(19) United States
(12) Patent Application Publication
(10) Pub. No.: US 2024/0276520 A1
(43) Pub. Date: Aug. 15, 2024

(54) METHOD FOR STOPPING MONITORING PHYSICAL DOWNLINK CONTROL CHANNEL AND COMMUNICATION APPARATUS

(71) Applicant: HUAWEI TECHNOLOGIES CO., LTD., Shenzhen (CN)

(72) Inventors: Wenwen HUANG, Shenzhen (CN); Xiaolei TIE, Shanghai (CN); Yifan XUE, Beijing (CN)

(21) Appl. No.: 18/621,994

(22) Filed: Mar. 29, 2024

Related U.S. Application Data
(63) Continuation of application No. PCT/CN2022/111747, filed on Aug. 11, 2022.

(30) Foreign Application Priority Data
Sep. 30, 2021 (CN) 202111164061.8
Nov. 5, 2021 (CN) 202111309099.X

(51) Int. Cl. H04W 72/232; H04W 72/0457; H04W 72/1273; H04W 76/20

(52) U.S. Cl. CPC H04W 72/232; H04W 72/0457; H04W 72/1273; H04W 76/20

(57) ABSTRACT

A method for stopping monitoring a physical downlink control channel. A network device sends first DCI to a terminal device on an active DL BWP. The terminal device runs a timer, where the timer is used for BWP switching. The terminal device stops, based on the first DCI, monitoring a PDCCH within a first duration, and suspends running of the timer. The terminal device continues to run the timer after the first duration. The terminal device performs DL BWP switching when the timer expires. The network device runs a timer, suspends running of the timer within a first duration, and continues to run the timer after the first duration. The network device performs DL BWP switching when the timer expires.

### CROSS-REFERENCE TO RELATED APPLICATIONS

This application is a continuation of International Application No. PCT/CN2022/111747, filed on Aug. 11, 2022, which claims priorities to Chinese Patent Application No. 202111164061.8, filed on Sep. 30, 2021, and to Chinese Patent Application No. 202111309099.X, filed on Nov. 5, 2021. All of the aforementioned patent applications are hereby incorporated by reference in their entireties.

### TECHNICAL FIELD

This application relates to the communication field, and in particular, to a method for stopping monitoring a physical downlink control channel and a communication apparatus.

### BACKGROUND

A physical downlink control channel (PDCCH) is used to carry scheduling information of uplink or downlink data. A terminal device periodically monitors the PDCCH to obtain the scheduling information. In response to detecting that the PDCCH carries the scheduling information, based on the scheduling information, the terminal device receives the downlink data through a physical downlink shared channel (PDSCH) or send the uplink data through a physical uplink shared channel (PUSCH). However, in response to there being no service transmission between a network device and the terminal device, the network device does not send the PDCCH to the terminal device, but the terminal device still periodically monitors the PDCCH. This increases power consumption of the terminal device.

Currently, in an active downlink bandwidth part (BWP), the network device uses a PDCCH monitoring skipping mechanism or a search space set group (SSSG) switching mechanism to reduce PDCCH monitoring, so as to reduce the power consumption of the terminal device. For each cell, the network device configures a plurality of downlink BWPs and/or a plurality of uplink BWPs for the terminal device, and the network device dynamically switches an active BWP.

However, in response to the terminal device supporting both the PDCCH monitoring skipping mechanism and a BWP switching mechanism, how the terminal device stops monitoring the PDCCH is not clearly defined.

### SUMMARY

Embodiments described herein provide a method for stopping monitoring a physical downlink control channel PDCCH and a communication apparatus. In response to a terminal device supporting both a PDCCH monitoring skipping mechanism and a BWP switching mechanism, time for stopping monitoring a PDCCH is determined, to help reduce power consumption of the terminal device.

According to a first aspect, at least one embodiment provides a method for stopping monitoring a physical downlink control channel PDCCH. The method includes: A terminal device receives first downlink control information (DCI) from a network device on an active downlink (DL) BWP, where the first DCI indicates the terminal device to stop monitoring a PDCCH within a first duration, and the PDCCH on which monitoring is stopped includes a PDCCH in a type 3 common search space set and a PDCCH in a terminal device-specific search space set. The terminal device runs a timer, where the timer is used for BWP switching, and an expiration moment of the timer is earlier than an end moment of the first duration. The terminal device stops monitoring the PDCCH within the first duration and before the timer expires. The terminal device performs DL BWP switching in response to the timer expiring, and monitors the PDCCH on a switched-to DL BWP.

The first DCI is carried on the PDCCH. The terminal device detects the first DCI on the PDCCH, stop, based on the first DCI, monitoring the PDCCH within the first duration, and continue to monitor the PDCCH after the first duration. The PDCCH on which monitoring is stopped includes the PDCCH in the type 3 common search space set and the PDCCH in the terminal device-specific search space set. For common search space sets of other types, for example, a type 0 common search space set, a type OA common search space set, a type 1 common search space set, and a type 2 common search space set, the UE skips or does not skip monitoring a PDCCH for DCI scrambled by a C-RNTI, an MCS-C-RNTI, or a CS-RNTI. This is not limited in at least one embodiment. For the type 0 common search space set, the type 0A common search space set, the type 1 common search space set, and the type 2 common search space set, whether the UE monitors an SI-RNTI, an RA-RNTI, a TC-RNTI, or a P-RNTI is not limited in at least one embodiment.

In response to a C-DRX mechanism being further configured for the terminal device, the first DCI indicates the terminal device to stop monitoring the PDCCH within the first duration in an active duration for C-DRX. In the active duration for the C-DRX, the terminal device stops monitoring the PDCCH within the first duration, and after the first duration, the terminal device continues to monitor the PDCCH in the active duration.

A unit of the first duration is a second, a millisecond, a frame, a subframe, a slot, a PDCCH monitoring periodicity, a quantity of PDCCH monitoring occasions, a slot set including several consecutive slots, or the like. This is not limited in at least one embodiment. For example, the first duration is eight slots, and the terminal device stops monitoring the PDCCH in the eight slots.

A start moment of the first duration is at the beginning of a slot in which the first DCI is located, at the beginning of a next slot for the first DCI, or at the beginning of a next symbol of an end symbol for the first DCI. This is not limited in at least one embodiment.

Optionally, a length of the first duration is configured by using RRC or indicated by the first DCI. A specific RRC configuration manner or a DCI indication manner is not limited in at least one embodiment.

For example, the network device sends the first DCI to the terminal device on the active DL BWP, where the first DCI indicates the terminal device to stop monitoring the PDCCH within the first duration, and indicates the length of the first duration.

For example, the network device sends the first DCI to the terminal device on the active DL BWP, where the first DCI indicates the terminal device to stop monitoring the PDCCH within the first duration. RRC signaling is sent to the terminal device on the active DL BWP. The RRC signaling indicates the length of the first duration.

Optionally, the length of the first duration is predefined in a protocol.

A duration of the timer is configured by the network device by using RRC signaling or predefined in a protocol. A unit of the duration of the timer is a second, a millisecond, a frame, a subframe, a slot, or the like. This is not limited in at least one embodiment. For example, the duration of the timer is three milliseconds.

In response to a condition for starting or restarting the timer being met (for example, the first DCI includes scheduling information), the terminal device starts or restarts the timer and runs the timer, to be specific, the timer decreases in descending order per subframe or per half subframe. After the timer expires, the terminal device performs DL BWP switching. In response to the condition for restarting the timer being met before the timer expires, the timer is restarted, that is, the timer is started to run again.

The expiration moment of the timer is earlier than the end moment of the first duration. For example, the first duration is greater than a duration within which the timer expires. For example, the first duration is greater than the duration within which the timer expires, the first duration is eight slots, and the duration of the timer is three milliseconds, namely, six slots.

A specific time location at which the timer is started or restarted is at the beginning of the slot in which the first DCI is located, at a start location of the next slot for the first DCI, or at a start location of the next symbol of the end symbol for the first DCI. This is not limited in at least one embodiment.

The end moment of the first duration is later than the expiration moment of the timer. In response to the timer expiring, a duration for stopping monitoring the PDCCH does not end, but the terminal device monitors the PDCCH on the switched-to DL BWP. The switched-to DL BWP is a new active DL BWP. The switched-to DL BWP is also referred to as a default DL BWP.

According to the method for stopping monitoring a PDCCH provided in at least one embodiment, the network device indicates the terminal device to stop monitoring the PDCCH within the first duration, and configures the timer used for BWP switching. The terminal device runs the timer and starts to stop monitoring the PDCCH, stops monitoring the PDCCH within the first duration and before the timer expires, and monitors the PDCCH on the switched-to BWP. In the method, the timer is run and PDCCH monitoring is started to be stopped, and running time of the timer is not changed. Therefore, the impact on the protocol is low, and the implementation is simple.

With reference to the first aspect, in some implementations of the first aspect, that the terminal device runs a timer includes: The terminal device starts or restarts the timer in response to the terminal device receiving indication information from the network device on the active DL BWP. The indication information is used to schedule the terminal device to transmit a PDSCH or a PUSCH, or the indication information indicates the terminal device to perform DL BWP switching, and the indication information is carried in the first DCI or DCI other than the first DCI.

With reference to the first aspect, in some implementations of the first aspect, the length of the first duration is configured by using the RRC or indicated by the first DCI.

With reference to the first aspect, in some implementations of the first aspect, the terminal device determines the start moment of the first duration based on at least one of the following information: a time offset between the start moment of the first duration and the first DCI; a maximum value between a minimum slot offset and a duration for parsing the first DCI, where the minimum slot offset is a minimum slot offset between a PDCCH carrying the first DCI and a PDSCH that is allowed to be scheduled by using the first DCI; a moment after a hybrid automatic repeat request (HARQ) corresponding to a PDSCH is fed back in response to the PDSCH being scheduled by using the first DCI; or a moment after a PUSCH being transmitted in response to the PUSCH being scheduled by using the first DCI.

According to the method for stopping monitoring a PDCCH provided in at least one embodiment, the time offset between the start moment of the first duration and the second DCI is determined based on at least one of the time offset between the start moment of the first duration and the second DCI, the maximum value between the minimum slot offset and the duration for parsing the second DCI, or the moment after the HARQ corresponding to the PDSCH is fed back in response to the PDSCH being scheduled by using the second DCI, and whether the first duration and a BWP switch delay overlap does not need to be considered. This reduces complexity of processing by the terminal device.

According to a second aspect, at least one embodiment provides a method for stopping monitoring a physical downlink control channel PDCCH. The method includes: A terminal device receives first downlink control information DCI from a network device on an active downlink DL bandwidth part BWP, where the first DCI indicates the terminal device to stop monitoring a PDCCH within a first duration, and the PDCCH on which monitoring is stopped includes a PDCCH in a type 3 common search space set and a PDCCH in a terminal device-specific search space set. The terminal device runs a timer, where the timer is used for BWP switching. The terminal device stops, based on the first DCI, monitoring the PDCCH within the first duration, and suspends running of the timer. The terminal device continues to run the timer after the first duration. The terminal device performs DL BWP switching in response to the timer expiring.

A start moment of the first duration is at the beginning of a slot in which the first DCI is located, at the beginning of a next slot for the first DCI, or at the beginning of a next symbol of an end symbol for the first DCI. This is not limited in at least one embodiment.

Optionally, a length of the first duration is configured by using RRC or indicated by the first DCI. A specific RRC configuration manner or a DCI indication manner is not limited in at least one embodiment.

For example, the network device sends the first DCI to the terminal device on the active DL BWP, where the first DCI indicates the terminal device to stop monitoring the PDCCH within the first duration, and indicates the length of the first duration.

For example, the network device sends the first DCI to the terminal device on the active DL BWP, where the first DCI indicates the terminal device to stop monitoring the PDCCH within the first duration. RRC signaling is sent to the terminal device on the active DL BWP. The RRC signaling indicates the length of the first duration.

Optionally, the length of the first duration is predefined in a protocol.

A duration of the timer is configured by the network device by using RRC signaling or predefined in a protocol. A unit of the duration of the timer is a second, a millisecond, a frame, a subframe, a slot, or the like. This is not limited in at least one embodiment. For example, the duration of the timer is three milliseconds.

In response to a condition for starting or restarting the timer being met (for example, the first DCI includes scheduling information), the terminal device starts or restarts the timer and runs the timer, to be specific, the timer decreases in descending order per subframe or per half subframe. After the timer expires, the terminal device performs DL BWP switching. In response to the condition for restarting the timer being met before the timer expires, the timer is restarted, that is, the timer is started to run again.

A specific time location at which the timer is started or restarted is at the beginning of the slot in which the first DCI is located, at a start location of the next slot for the first DCI, or at a start location of the next symbol of the end symbol for the first DCI. This is not limited in at least one embodiment.

The terminal device suspends running of the timer within the duration for stopping monitoring the PDCCH, that is, within the duration for stopping monitoring the PDCCH, suspending of the timer decreases in descending order per subframe or per half subframe.

After performing DL BWP switching, the terminal device monitors the PDCCH on a switched-to DL BWP.

According to the method for stopping monitoring a PDCCH provided in at least one embodiment, the network device indicates the terminal device to stop monitoring the PDCCH within the first duration, and configures the timer used for BWP switching. In response to stopping monitoring the PDCCH, the terminal device suspends running of the timer, and continues to run the timer after the first duration, that is, stopping monitoring the PDCCH and stopping running the timer are run in different time periods. This avoids a problem that the timer easily expires due to stopping monitoring the PDCCH. In addition, the terminal device stops monitoring the PDCCH within the first duration, to reduce power consumption of the terminal device.

With reference to the second aspect, in some implementations of the second aspect, that the terminal device runs a timer includes: The terminal device starts or restarts the timer in response to the terminal device receiving indication information from the network device on the active DL BWP. The indication information is used to schedule the terminal device to transmit a PDSCH or a PUSCH, or the indication information indicates the terminal device to perform DL BWP switching, and the indication information is carried in the first DCI or DCI other than the first DCI.

With reference to the second aspect, in some implementations of the second aspect, the length of the first duration is configured by using the radio resource control RRC or indicated by the first DCI.

With reference to the second aspect, in some implementations of the second aspect, the terminal device determines the start moment of the first duration based on at least one of the following information: a time offset between the start moment of the first duration and the first DCI; a maximum value between a minimum slot offset and a duration for parsing the first DCI, where the minimum slot offset is a minimum slot offset between a PDCCH carrying the first DCI and a PDSCH that is allowed to be scheduled by using the first DCI; a moment after a HARQ corresponding to a PDSCH is fed back in response to the PDSCH being scheduled by using the first DCI; or a moment after a PUSCH is transmitted in response to the PUSCH being scheduled by using the first DCI.

According to the method for stopping monitoring a PDCCH provided in at least one embodiment, the time offset between the start moment of the first duration and the first DCI is determined based on at least one of the time offset between the start moment of the first duration and the first DCI, the maximum value between the minimum slot offset and the duration for parsing the first DCI, or the moment after the HARQ corresponding to the PDSCH is fed back in response to the PDSCH being scheduled by using the first DCI, and whether the first duration and a BWP switch delay overlap is able to not be considered. This reduces complexity of processing by the terminal device.

According to a third aspect, at least one embodiment provides a method for stopping monitoring a physical downlink control channel PDCCH. The method includes: A terminal device receives second DCI from a network device on an active DL BWP, where the second DCI indicates to perform DL BWP switching and stop monitoring a PDCCH within a first duration, the PDCCH on which monitoring is stopped includes a PDCCH in a type 3 common search space set and a PDCCH in a terminal device-specific search space set, and the second DCI is used to schedule transmission of a PDSCH. The terminal device performs, based on the second DCI, DL BWP switching, and stops monitoring the PDCCH on a switched-to DL BWP. A start moment of the first duration is determined based on at least one of the following information: a next slot after a BWP switch delay; a slot in which the PDSCH is transmitted on the switched-to DL BWP; a slot next to a slot in which the PDSCH is transmitted on the switched-to DL BWP; a time offset between the start moment of the first duration and the second DCI; a maximum value between a minimum slot offset and a duration for parsing the second DCI, where the minimum slot offset is a minimum slot offset between a PDCCH carrying the second DCI and a PDSCH that is allowed to be scheduled by using the second DCI; or a moment after a HARQ corresponding to a PDSCH is fed back in response to the PDSCH being scheduled by using the second DCI.

The second DCI is carried on the PDCCH. The terminal device detects the second DCI on the PDCCH on the active DL BWP, stops, based on the second DCI, monitoring the PDCCH within the first duration, and performs DL BWP switching. The PDCCH on which monitoring is stopped includes the PDCCH in the type 3 common search space set and the PDCCH in the terminal device-specific search space set.

A BWP indicator field in the second DCI indicates DL BWP switching, and indicates to stop monitoring the PDCCH within the first duration and schedule the transmission of the PDSCH. Specifically, the second DCI carries scheduling information of the PDSCH, and the BWP indicator field in the second DCI indicates an ID of a DL BWP. The ID is different from an ID of the currently active DL BWP. The terminal device switches to the DL BWP in the indicator field in the second DCI based on the second DCI.

The start moment of the first duration is at the beginning of a slot in which first DCI is located, at a start location of a next slot for first DCI, or at a start location of a next symbol of an end symbol for first DCI. This is not limited in at least one embodiment.

Optionally, a length of the first duration is configured by using RRC or indicated by the first DCI. A specific RRC configuration manner or a DCI indication manner is not limited in at least one embodiment.

For example, the network device sends the second DCI to the terminal device on the active DL BWP, where the second DCI indicates the terminal device to stop monitoring the PDCCH within the first duration, and indicates the length of the first duration.

For example, the network device sends the second DCI to the terminal device on the active DL BWP, where the second DCI indicates the terminal device to stop monitoring the PDCCH within the first duration. RRC signaling is sent to the terminal device on the active DL BWP. The RRC signaling indicates the length of the first duration.

Optionally, the length of the first duration is predefined in a protocol.

The start moment of the first duration is in the next slot after the BWP switch delay, in the slot in which the PDSCH is transmitted on the switched-to DL BWP, or in the slot next to the slot in which the PDSCH is transmitted on the switched-to DL BWP.

The start moment of the first duration is determined based on at least one of the time offset between the start moment of the first duration and the second DCI, the maximum value between the minimum slot offset and the duration for parsing the second DCI, or the moment after the HARQ corresponding to the PDSCH is fed back in response to the PDSCH being scheduled by using the second DCI.

According to the method for stopping monitoring a PDCCH provided in at least one embodiment, in response to the start moment of the first duration being in the next slot after the BWP switch delay, in the slot in which the PDSCH is transmitted on the switched-to DL BWP, or in the slot next to the slot in which the PDSCH is transmitted on the switched-to DL BWP, so that there is no overlap between the first duration and the BWP switch delay. This helps the terminal device stop monitoring the PDCCH for a long time, and helps reduce power consumption of the terminal device. In addition, the time offset between the start moment of the first duration and the second DCI is determined based on at least one of the time offset between the start moment of the first duration and the second DCI, the maximum value between the minimum slot offset and the duration for parsing the second DCI, or the moment after the hybrid automatic repeat request (HARQ) corresponding to the PDSCH is fed back in response to the PDSCH being scheduled by using the second DCI, and whether the first duration and a BWP switch delay overlap is able to not be considered. This reduces complexity of processing by the terminal device.

With reference to the third aspect, in some implementations of the third aspect, the length of the first duration is configured by using the radio resource control RRC or indicated by the second DCI.

With reference to the third aspect, in some implementations of the third aspect, the second DCI further indicates the terminal device to switch to a first search space set group, where the first search space set group is a search space set group on the switched-to DL BWP. The method further includes: The terminal device switches to the first search space set group on the switched-to DL BWP.

With reference to the third aspect, in some implementations of the third aspect, a moment at which the terminal device switches to the first search space set group on the switched-to DL BWP is a next slot or a next symbol after the first duration, or a slot or a symbol that is the same as the start moment of the first duration.

With reference to the third aspect, in some implementations of the third aspect, the moment at which the terminal device switches to the first search space set group on the switched-to DL BWP is determined based on at least one of the following information, and is different from the start moment of the first duration: the next slot after the BWP switch delay; the slot in which the PDSCH is transmitted on the switched-to DL BWP; the slot next to the slot in which the PDSCH is transmitted on the switched-to DL BWP; the time offset between the start moment of the first duration and the second DCI; the maximum value between the minimum slot offset and the duration for parsing the second DCI; or the moment after the hybrid automatic repeat request HARQ corresponding to the PDSCH is fed back in response to the PDSCH being scheduled by using the second DCI.

According to a fourth aspect, at least one embodiment provides a method for stopping monitoring a physical downlink control channel PDCCH. The method includes: A network device sends first downlink control information DCI to a terminal device on an active downlink DL bandwidth part BWP, where the first DCI indicates the terminal device to stop monitoring a PDCCH within a first duration, and the PDCCH on which monitoring is stopped includes a PDCCH in a type 3 common search space set and a PDCCH in a terminal device-specific search space set. The network device runs a timer, where the timer is used for BWP switching. The network device suspends running of the timer within the first duration. The network device continues to run the timer after the first duration. The network device performs DL BWP switching in response to the timer expiring.

According to the method for stopping monitoring a PDCCH provided in at least one embodiment, the network device indicates the terminal device to stop monitoring the PDCCH within the first duration, and configures the timer used for BWP switching. In response to stopping monitoring the PDCCH, the network device suspends running of the timer, and continues to run the timer after the first duration, that is, stopping monitoring the PDCCH and stopping running the timer are run in different time periods. This avoids a problem that the timer easily expires due to stopping monitoring the PDCCH.

With reference to the fourth aspect, in some implementations of the fourth aspect, a length of the first duration is configured by using radio resource control RRC or indicated by the first DCI.

With reference to the fourth aspect, in some implementations of the fourth aspect, the network device determines a start moment of the first duration based on at least one of the following information: a time offset between the start moment of the first duration and the first DCI; a moment after a hybrid automatic repeat request HARQ corresponding to a PDSCH is fed back in response to the PDSCH being scheduled by using the first DCI; or a moment after a PUSCH is transmitted in response to the PUSCH being scheduled by using the first DCI.

According to a fifth aspect, at least one embodiment provides a method for stopping monitoring a physical downlink control channel PDCCH. The method includes: A network device sends second downlink control information DCI to a terminal device on an active downlink DL bandwidth part BWP, where the second DCI indicates to perform DL BWP switching and the terminal device to stop monitoring a PDCCH within a first duration, the PDCCH on which monitoring is stopped includes a PDCCH in a type 3 common search space set and a PDCCH in a terminal device-specific search space set, and the second DCI is used to schedule transmission of a physical downlink shared channel PDSCH. The network device performs DL BWP switching based on the second DCI. A start moment of the first duration is determined based on at least one of the following information: a next slot after a BWP switch delay; a slot in which the PDSCH is transmitted on a switched-to DL BWP; a slot next to a slot in which the PDSCH is transmitted on a switched-to DL BWP; a time offset between the start moment of the first duration and the second DCI; a maximum value between a minimum slot offset and a duration for parsing the second DCI, where the minimum slot offset is a minimum slot offset between a PDCCH carrying the second DCI and a PDSCH that is allowed to be scheduled by using the second DCI; or a moment after a hybrid automatic repeat request HARQ corresponding to a PDSCH is fed back in response to the PDSCH being scheduled by using the second DCI.

With reference to the fifth aspect, in some implementations of the fifth aspect, a length of the first duration is configured by using radio resource control RRC or indicated by the second DCI.

With reference to the fifth aspect, in some implementations of the fifth aspect, the second DCI further indicates the terminal device to switch to a first search space set group, where the first search space set group is a search space set group on the switched-to DL BWP. The method further includes: The network device switches to the first search space set group on the switched-to DL BWP.

With reference to the fifth aspect, in some implementations of the fifth aspect, a moment at which the network device switches to the first search space set group on the switched-to DL BWP is a next slot or a next symbol after the first duration, or a slot or a symbol that is the same as the start moment of the first duration.

With reference to the fifth aspect, in some implementations of the fifth aspect, the moment at which the network device switches to the first search space set group on the DL BWP is determined based on at least one of the following information, and is different from the start moment of the first duration: the next slot after the BWP switch delay; the slot in which the PDSCH is transmitted on the switched-to DL BWP; the slot next to the slot in which the PDSCH is transmitted on the switched-to DL BWP; the time offset between the start moment of the first duration and the second DCI; the maximum value between the minimum slot offset and the duration for parsing the second DCI; or the moment after the hybrid automatic repeat request HARQ corresponding to the PDSCH is fed back in response to the PDSCH being scheduled by using the second DCI.

According to a sixth aspect, at least one embodiment provides a communication apparatus, including: a transceiver unit, configured to receive first downlink control information DCI from a network device on an active downlink DL bandwidth part BWP, where the first DCI indicates the apparatus to stop monitoring a PDCCH within a first duration, and the PDCCH on which monitoring is stopped includes a PDCCH in a type 3 common search space set and a PDCCH in an apparatus-specific search space set; and a processing unit, configured to: run a timer, where the timer is used for BWP switching, and an expiration moment of the timer is earlier than an end moment of the first duration; stop monitoring the PDCCH within the first duration and before the timer expires; and perform DL BWP switching in response to the timer expiring, and monitoring the PDCCH on a switched-to DL BWP.

With reference to the sixth aspect, in some implementations of the sixth aspect, the processing unit is further configured to: start or restart the timer in response to indication information from the network device being received on the active DL BWP, where the indication information is used to schedule the apparatus to transmit a physical downlink shared channel PDSCH or a physical uplink shared channel PUSCH, or the indication information indicates the apparatus to perform DL BWP switching, and the indication information is carried in the first DCI or DCI other than the first DCI.

With reference to the sixth aspect, in some implementations of the sixth aspect, a length of the first duration is configured by using radio resource control RRC or indicated by the first DCI.

With reference to the sixth aspect, in some implementations of the sixth aspect, the apparatus determines a start moment of the first duration based on at least one of the following information: a time offset between the start moment of the first duration and the first DCI; a maximum value between a minimum slot offset and a duration for parsing the first DCI, where the minimum slot offset is a minimum slot offset between a PDCCH carrying the first DCI and a PDSCH that is allowed to be scheduled by using the first DCI; a moment after a hybrid automatic repeat request HARQ corresponding to a PDSCH is fed back in response to the PDSCH being scheduled by using the first DCI; or a moment after a PUSCH is transmitted in response to the PUSCH being scheduled by using the first DCI.

According to a seventh aspect, at least one embodiment provides a communication apparatus, including a transceiver unit, configured to receive first downlink control information DCI from a network device on an active downlink DL bandwidth part BWP, where the first DCI indicates the apparatus to stop monitoring a PDCCH within a first duration, and the PDCCH on which monitoring is stopped includes a PDCCH in a type 3 common search space set and a PDCCH in an apparatus-specific search space set; and a processing unit, configured to: run a timer, where the timer is used for BWP switching; stop, based on the first DCI, monitoring the PDCCH within the first duration, and suspend running of the timer; continue to run the timer after the first duration; and perform DL BWP switching in response to the timer expiring.

With reference to the seventh aspect, in some implementations of the seventh aspect, the processing unit is further configured to: start or restart the timer in response to indication information from the network device being received on the active DL BWP, where the indication information is used to schedule the apparatus to transmit a physical downlink shared channel PDSCH or a physical uplink shared channel PUSCH, or the indication information indicates the apparatus to perform DL BWP switching, and the indication information is carried in the first DCI or DCI other than the first DCI.

With reference to the seventh aspect, in some implementations of the seventh aspect, a length of the first duration is configured by using radio resource control RRC or indicated by the first DCI.

With reference to the seventh aspect, in some implementations of the seventh aspect, the apparatus determines a start moment of the first duration based on at least one of the following information: a time offset between the start moment of the first duration and the first DCI; a maximum value between a minimum slot offset and a duration for parsing the first DCI, where the minimum slot offset is a minimum slot offset between a PDCCH carrying the first DCI and a PDSCH that is allowed to be scheduled by using the first DCI; a moment after a hybrid automatic repeat request HARQ corresponding to a PDSCH is fed back in response to the PDSCH being scheduled by using the first DCI; or a moment after a PUSCH is transmitted in response to the PUSCH being scheduled by using the first DCI.

According to an eighth aspect, at least one embodiment provides a communication apparatus, including a transceiver unit, configured to receive second downlink control information DCI from a network device on an active downlink DL bandwidth part BWP, where the second DCI indicates to perform DL BWP switching and stop monitoring a PDCCH within a first duration, the PDCCH on which monitoring is stopped includes a PDCCH in a type 3 common search space set and a PDCCH in an apparatus-specific search space set, and the second DCI is used to schedule transmission of a physical downlink shared channel PDSCH; and a processing unit, configured to: perform DL BWP switching based on the second DCI, and stop monitoring the PDCCH on a switched-to DL BWP. A start moment of the first duration is determined based on at least one of the following information: a next slot after a BWP switch delay; a slot in which the PDSCH is transmitted on the switched-to DL BWP; a slot next to a slot in which the PDSCH is transmitted on the switched-to DL BWP; a time offset between the start moment of the first duration and the second DCI; a maximum value between a minimum slot offset and a duration for parsing the second DCI, where the minimum slot offset is a minimum slot offset between a PDCCH carrying the second DCI and a PDSCH that is allowed to be scheduled by using the second DCI; or a moment after a hybrid automatic repeat request HARQ corresponding to a PDSCH is fed back in response to the PDSCH being scheduled by using the second DCI.

With reference to the eighth aspect, in some implementations of the eighth aspect, a length of the first duration is configured by using radio resource control RRC or indicated by the first DCI.

With reference to the eighth aspect, in some implementations of the eighth aspect, the second DCI further indicates the terminal device to switch to a first search space set group, where the first search space set group is a search space set group on the switched-to DL BWP. The method further includes: The terminal device switches to the first search space set group on the switched-to DL BWP.

With reference to the eighth aspect, in some implementations of the eighth aspect, a moment at which the terminal device switches to the first search space set group on the switched-to DL BWP is a next slot or a next symbol after the first duration, or a slot or a symbol that is the same as the start moment of the first duration.

With reference to the eighth aspect, in some implementations of the eighth aspect, the moment at which the terminal device switches to the first search space set group on the switched-to DL BWP is determined based on at least one of the following information, and is different from the start moment of the first duration: the next slot after the BWP switch delay; the slot in which the PDSCH is transmitted on the switched-to DL BWP; the slot next to the slot in which the PDSCH is transmitted on the switched-to DL BWP; the time offset between the start moment of the first duration and the second DCI; the maximum value between the minimum slot offset and the duration for parsing the second DCI; or the moment after the hybrid automatic repeat request HARQ corresponding to the PDSCH is fed back in response to the PDSCH being scheduled by using the second DCI.

According to a ninth aspect, at least one embodiment provides a communication apparatus, including a transceiver unit, configured to send first downlink control information DCI to a terminal device on an active downlink DL bandwidth part BWP, where the first DCI indicates the terminal device to stop monitoring a PDCCH within a first duration, and the PDCCH on which monitoring is stopped includes a PDCCH in a type 3 common search space set and a PDCCH in a terminal device-specific search space set; and a processing unit, configured to: run a timer, where the timer is used for BWP switching; suspend running of the timer within the first duration; and continue to run the timer after the first duration. The processing unit is further configured to perform DL BWP switching in response to the timer expiring.

With reference to the ninth aspect, in some implementations of the ninth aspect, a length of the first duration is configured by using radio resource control RRC or indicated by the first DCI.

With reference to the ninth aspect, in some implementations of the eighth aspect, the network device determines a start moment of the first duration based on at least one of the following information: a time offset between the start moment of the first duration and the first DCI; a moment after a hybrid automatic repeat request HARQ corresponding to a PDSCH is fed back in response to the PDSCH being scheduled by using the first DCI; or a moment after a PUSCH is transmitted in response to the PUSCH being scheduled by using the first DCI.

According to a tenth aspect, at least one embodiment provides a communication apparatus. The apparatus includes a transceiver unit and a processing unit. The transceiver unit is configured to send second downlink control information DCI to a terminal device on an active downlink DL bandwidth part BWP. The second DCI indicates to perform DL BWP switching and stop monitoring a PDCCH within a first duration, the PDCCH on which monitoring is stopped includes a PDCCH in a type 3 common search space set and a PDCCH in a terminal device-specific search space set, and the second DCI is used to schedule transmission of a physical downlink shared channel PDSCH. The processing unit is configured to perform DL BWP switching based on the second DCI. A start moment of the first duration is determined based on at least one of the following information: a next slot after a BWP switch delay; a slot in which the PDSCH is transmitted on a switched-to DL BWP; a slot next to a slot in which the PDSCH is transmitted on a switched-to DL BWP; a time offset between the start moment of the first duration and the second DCI; a maximum value between a minimum slot offset and a duration for parsing the second DCI, where the minimum slot offset is a minimum slot offset between a PDCCH carrying the second DCI and a PDSCH that is allowed to be scheduled by using the second DCI; or a moment after a hybrid automatic repeat request HARQ corresponding to a PDSCH is fed back in response to the PDSCH being scheduled by using the second DCI.

With reference to the tenth aspect, in some implementations of the tenth aspect, a length of the first duration is configured by using radio resource control RRC or indicated by the second DCI.

With reference to the tenth aspect, in some implementations of the tenth aspect, the second DCI further indicates the terminal device to switch to a first search space set group, where the first search space set group is a search space set group on the switched-to DL BWP. The processing unit is further configured to switch to the first search space set group on the switched-to DL BWP.

With reference to the tenth aspect, in some implementations of the tenth aspect, a moment at which the apparatus switches to the first search space set group on the switched-to DL BWP is a next slot or a next symbol after the first duration, or a slot or a symbol that is the same as the start moment of the first duration.

With reference to the tenth aspect, in some implementations of the tenth aspect, the moment at which the apparatus switches to the first search space set group on the switched-to DL BWP is determined based on at least one of the following information, and is different from the start moment of the first duration: the next slot after the BWP switch delay; the slot in which the PDSCH is transmitted on the switched-to DL BWP; the slot next to the slot in which the PDSCH is transmitted on the switched-to DL BWP; the time offset between the start moment of the first duration and the second DCI; the maximum value between the minimum slot offset and the duration for parsing the second DCI; or the moment after the hybrid automatic repeat request HARQ corresponding to the PDSCH is fed back in response to the PDSCH being scheduled by using the second DCI.

According to an eleventh aspect, at least one embodiment provides a communication apparatus, configured to perform the method according to any one of the foregoing aspects. Specifically, the apparatus includes units configured to perform the method according to any one of the foregoing aspects.

In a design, the apparatus includes modules corresponding to performing the methods/operations/steps/actions described in the foregoing aspects. The modules are hardware circuits, are software, or are implemented by hardware circuits in combination with software.

In another design, the apparatus is a communication chip. The communication chip includes an input circuit or interface configured to send information or data, and an output circuit or interface configured to receive information or data.

In another design, the apparatus is a communication device. The communication device includes a transmitter configured to send information or data, and a receiver configured to receive information or data.

In another design, the apparatus is configured to perform the method according to any one of the foregoing aspects. The apparatus is configured in the foregoing terminal device or network device, or the apparatus is the foregoing terminal device or network device.

According to a twelfth aspect, at least one embodiment provides another communication apparatus, including a processor and a memory. The memory is configured to store a computer program, and the processor is configured to invoke the computer program from the memory and run the computer program, so that the apparatus performs the method according to at least one embodiment.

Optionally, there are one or more processors, and there are one or more memories.

Optionally, the memory and the processor are integrated together, or the memory and the processor are separately disposed.

Optionally, the communication device further includes a transmitter and a receiver. The transmitter and the receiver are disposed separately, or are integrated together, and are referred to as a transceiver.

According to a thirteenth aspect, a communication system is provided, including an apparatus configured to implement the method according to any one of the foregoing aspects.

In at least one embodiment, the communication system further includes another device that interacts with the terminal device and/or the network device in the solutions provided in at least one embodiment.

According to a fourteenth aspect, a computer-readable medium is provided. The computer-readable medium stores a computer program (which is also referred to as code or instructions). In response to the computer program being run on a computer, the computer is enabled to perform the method according to at least one embodiment.

According to a fifteenth aspect, a computer program product is provided. The computer program product includes a computer program (which is also referred to as code or instructions). In response to the computer program being run, a computer is enabled to perform the method according to at least one embodiment.

### BRIEF DESCRIPTION OF DRAWINGS

FIG. 1 is a schematic diagram of a PDCCH monitoring skipping mechanism;

FIG. 2 is a schematic diagram of PDCCH monitoring periodicities of SS sets associated with an SSSG 0 and an SSSG 1;

FIG. 3 is a schematic diagram of BWP switching;

FIG. 4 is a schematic diagram of another BWP switching;

FIG. 5 is a schematic diagram of a communication system according to at least one embodiment;

FIG. 6 is a schematic flowchart of a method for stopping monitoring a PDCCH according to at least one embodiment;

FIG. 7 is a schematic diagram of stopping monitoring a PDCCH according to at least one embodiment;

FIG. 8 is a schematic flowchart of another method for stopping monitoring a PDCCH according to at least one embodiment;

FIG. 9 is another schematic diagram of stopping monitoring a PDCCH according to at least one embodiment;

FIG. 10 is a schematic flowchart of still another method for stopping monitoring a PDCCH according to at least one embodiment;

FIG. 11 is still another schematic diagram of stopping monitoring a PDCCH according to at least one embodiment;

FIG. 12 is another schematic diagram of stopping monitoring a PDCCH according to at least one embodiment;

FIG. 13 is still another schematic diagram of stopping monitoring a PDCCH according to at least one embodiment;

FIG. 14 is a schematic flowchart of a communication apparatus according to at least one embodiment;

FIG. 15 is a schematic flowchart of another communication apparatus according to at least one embodiment;

FIG. 16 is another schematic diagram of stopping monitoring a PDCCH according to at least one embodiment;

FIG. 17 is still another schematic diagram of stopping monitoring a PDCCH according to at least one embodiment;

FIG. 18 is a schematic flowchart of yet another method for stopping monitoring a PDCCH according to at least one embodiment;

FIG. 19 is another schematic diagram of stopping monitoring a PDCCH according to at least one embodiment;

FIG. 20 is still another schematic diagram of stopping monitoring a PDCCH according to at least one embodiment;

FIG. 21 is another schematic diagram of stopping monitoring a PDCCH according to at least one embodiment;

FIG. 22 is still another schematic diagram of stopping monitoring a PDCCH according to at least one embodiment; and

FIG. 23 is another schematic diagram of stopping monitoring a PDCCH according to at least one embodiment.

### DESCRIPTION OF EMBODIMENTS

The following describes technical solutions of at least one embodiment with reference to accompanying drawings.

The technical solutions in at least one embodiment are applied to various communication systems, for example, an LTE frequency division duplex (FDD) system, an LTE time division duplex (TDD) system, a 5th generation (5G) system, a new radio (NR) system, or another evolved communication system.

A terminal device in at least one embodiment is also referred to as user equipment (UE), a mobile station (MS), a mobile terminal (MT), an access terminal, a subscriber unit, a subscriber station, a mobile station, a mobile station, a remote station, a remote terminal, a mobile device, a user terminal, a terminal, a wireless communication device, a user agent, a user apparatus, or the like.

The terminal device is a device that provides voice/data connectivity for a user, for example, a handheld device or a vehicle-mounted device that has a wireless connection function. Currently, some terminals, for example, include a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a hand-held device or a computing device that has a wireless communication function or another processing device connected to a wireless modem, a vehicle-mounted device, a wearable device, a terminal device in a 5G network, and a terminal device in a future evolved public land mobile network (PLMN). This is not limited in at least one embodiment.

In addition, in at least one embodiment, the terminal device alternatively is a terminal device in an internet of things (IoT) system. An IoT is an important part of future development of information technologies. A main technical feature of the IoT is connecting things to a network by using a communication technology, to implement an intelligent network for human-machine interconnection and thing-thing interconnection.

In addition, a network device in at least one embodiment is a device configured to communicate with the terminal device. The network device is also referred to as an access network device or a radio access network device, is a transmission reception point (TRP), is an evolved base station (eNB or eNodeB) in an LTE system, is a home base station (for example, home evolved NodeB, or home NodeB, HNB) or a baseband unit (BBU), or is a radio controller in a cloud radio access network (CRAN) scenario. Alternatively, the network device is a relay station, an access point, a vehicle-mounted device, a wearable device, a network device in a 5G network, a network device in a future evolved PLMN network, or the like, is an access point (AP) in a WLAN, is a gNB in a new radio (NR) system, or is a satellite base station in a satellite communication system, or the like. This is not limited in at least one embodiment.

In a network structure, the network device includes a central unit (CU) node, a distributed unit (DU) node, a RAN device including a CU node and a DU node, or a RAN device including a control plane CU node (CU-CP node), a user plane CU node (CU-UP node), and a DU node.

The network device serves a cell, and the terminal device communicates with the cell by using a transmission resource (for example, a frequency domain resource or a spectrum resource) allocated by the network device. The cell belongs to a macro base station (for example, a macro eNB or a macro gNB), or belongs to a base station corresponding to a small cell. The small cell herein includes a metro cell, a micro cell, a pico cell, a femto cell, and the like. These small cells have characteristics of small coverage and low transmit power, and are applicable to providing high-rate data transmission services.

In at least one embodiment, the terminal device or the network device includes a hardware layer, an operating system layer running on the hardware layer, and an application layer running on the operating system layer. The hardware layer includes hardware such as a central processing unit (CPU), a memory management unit (MMU), and a memory (also referred to as a main memory). An operating system is any one or more types of computer operating systems that implement service processing through a process, for example, a Linux operating system, a Unix operating system, an Android operating system, an iOS operating system, or a Windows operating system. The application layer includes applications such as a browser, contacts, word processing software, and instant messaging software. In addition, a specific structure of an execution body of a method provided in at least one embodiment is not particularly limited in at least one embodiment, provided that a program that records code of the method provided in at least one embodiment is run to perform communication according to the method provided in at least one embodiment. For example, the execution body of the method provided in at least one embodiment is the terminal device or the network device, or a functional module that invokes and executes the program in the terminal device or the network device.

In addition, aspects or features of at least one embodiment is implemented as a method, an apparatus, or a product that uses standard programming and/or engineering technologies. The term “product” used in at least one embodiment covers a computer program that is accessed from any computer-readable component, carrier or medium. For example, the computer-readable medium includes but is not limited to: a magnetic storage component (for example, a hard disk, a floppy disk or a magnetic tape), an optical disc (for example, a compact disc (CD), and a digital versatile disc (DVD)), a smart card and a flash memory component (for example, an erasable programmable read-only memory (EPROM), a card, a stick, or a key drive). In addition, various storage media described in at least one embodiment represents one or more devices and/or other machine-readable media that are configured to store information. The term “machine-readable media” includes but is not limited to a wireless channel, and various other media that stores, includes, and/or carries instructions and/or data.

To facilitate understanding of embodiments described herein, related terms in at least one embodiment are described.

### 1. PDCCH Monitoring Skipping Mechanism

The PDCCH monitoring skipping mechanism means that a network device indicates, based on downlink control information (DCI), that a terminal device skips monitoring a PDCCH in a period of time. In other words, the terminal device stops monitoring the PDCCH in the period of time or not monitor the PDCCH in the period of time. The terminal device enters a sleep state (which is also referred to as a standby state) within a duration for stopping monitoring the PDCCH, to reduce power consumption.

For example, FIG. 1 is a schematic diagram of the PDCCH monitoring skipping mechanism. As shown in FIG. 1, the terminal device periodically monitors a PDCCH by using two slots as a periodicity, and a block filled with a black pattern in the figure indicates a PDCCH monitoring occasion that is to be monitored.

In response to the terminal device receiving the DCI that indicates the terminal device to stop monitoring the PDCCH in the period of time, the terminal device stops monitoring the PDCCH in the period of time after the DCI is received. A duration of the period of time is the duration for stopping monitoring the PDCCH. After the duration for stopping monitoring the PDCCH, the terminal device continues to monitor the PDCCH. The duration for stopping monitoring the PDCCH is indicated by the DCI, or is configured though radio resource control (RRC) signaling, or the duration for stopping monitoring the PDCCH is predefined in a protocol. Particularly, in response to the network device configuring, through the RRC signaling, a plurality of durations for stopping monitoring the PDCCH, the network device indicates, based on the DCI, that one of the plurality of durations for stopping monitoring the PDCCH is used as a current duration for stopping monitoring the PDCCH.

In FIG. 1, that the duration for stopping monitoring the PDCCH includes eight slots is merely used as an example. This is not limited in at least one embodiment.

A type 3 common search space set is mainly used to monitor a PDCCH that carries DCI scrambled by any one of the following radio network temporary identifiers (RNTIs): an interruption-RNTI (INT-RNTI), a slot format indication-RNTI (SFI-RNTI), a transmit power control-physical uplink shared channel-RNTI (TPC-PUSCH-RNTI), a transmit power control-physical uplink control channel-RNTI (TPC-PUCCH-RNTI), a transmit power control-sounding reference signal-RNTI (TPC-SRS-RNTI), a cancellation indication-RNTI (CI-RNTI), a cell-RNTI (cell-RNTI, C-RNTI) on a primary cell, a modulation and coding scheme-C-RNTI (MCS-C-RNTI), a configured scheduling-RNTI (CS-RNTI), a power saving-RNTI (PS-RNTI) power reduction, or the like. User equipment-specific search space set is used to monitor a PDCCH that carries DCI scrambled by any one of the following RNTIs: a C-RNTI, an MCS-C-RNTI, a semi-persistent-channel state indication-RNTI (SP-CSI-RNTI), a CS-RNTI, a side link-RNTI (SL-RNTI), an SL-CS-RNTI, a side link semi-persistent scheduling vehicle-RNTI (SL semi-persistent scheduling V-RNTI), and the like.

A type 0 common search space set and a type 0A common search space set is used to monitor a PDCCH for DCI scrambled by a system information-RNTI (SI-RNTI). A type 1 common search space set is used to monitor a PDCCH for DCI scrambled by a random access-RNTI (RA-RNTI), a message B-RNTI (MsgB-RNTI), or a temporary cell-RNTI (TC-RNTI). A type 2 common search space set is used to monitor a PDCCH for DCI scrambled by a paging-RNTI (P-RNTI). For the type 0 common search space set, the type OA common search space set, the type 1 common search space set, and the type 2 common search space set, the UE monitors, in a slot in which the UE monitors the PDCCH for the DCI scrambled by the SI-RNTI, the RA-RNTI, the MsgB-RNTI, or the P-RNTI, the PDCCH for the DCI (DCI format 0_0 and DCI format 1_0) scrambled by the C-RNTI, the MCS-C-RNTI, or the CS-RNTI.

Skipping PDCCH monitoring by the terminal device is also referred to as stopping PDCCH monitoring, not monitoring a PDCCH, or the like. This term is not limited in embodiments described herein.

In response to the terminal device being further configured with a connected mode-discontinuous reception (C-DRX) mechanism, the PDCCH monitoring skipping mechanism is also used in an active duration for C-DRX, in other words, the terminal device stops monitoring the PDCCH in a period of time in the active duration for the C-DRX.

### 2. Search Space Set Group (SSSG) Switching Mechanism

The SSSG switching mechanism means that a network device indicates a terminal device to switch from a current search space set group to another search space set group to monitor a PDCCH. In response to a periodicity for monitoring the PDCCH in the switched-to search space set group being greater than a periodicity for monitoring the PDCCH in a switched-from search space set group, that is, in response to PDCCH monitoring occasions of the switched-to search space set group being sparse compared with PDCCH monitoring occasions of the switched-from search space set group, power consumption of the terminal device is reduced.

For one downlink BWP, the network device configures a plurality of search space sets (SS sets) for the terminal device, and groups the plurality of configured SS sets. A specific quantity of groups is not limited in at least one embodiment. For example, the network device groups the plurality of configured SS sets into two groups or three groups.

For example, the network device groups the plurality of configured SS sets into two groups: an SSSG 0 and an SSSG 1. The network device configures, in configuration information of an SS set, that the SS set belongs to the SSSG 0 or the SSSG 1. The terminal device monitors the PDCCH based on the SS set of the SSSG 0 or the SSSG 1. The SSSG 0 is also described as an SSSG0, and the SSSG 1 is also described as an SSSG1. This is not limited in at least one embodiment.

The SSSG 0 is understood as an index of an SSSG is 0, and the SSSG 1 is understood as that an index of an SSSG is 1.

Optionally, one SS set belongs to a plurality of SSSGs, that is, belongs to the SSSG 0 and also belong to the SSSG 1.

Optionally, an SSSG parameter is not configured in the configuration information of the SS set, and the SS set is not grouped and belongs to neither the SSSG0 nor the SSSG1. For an SS set that is not grouped in the DL BWP, the UE monitors the PDCCH based on configuration information of the SS set. This is not limited in at least one embodiment.

PDCCH monitoring occasions of SS sets associated with different SSSGs on one downlink BWP is different, that is, PDCCH monitoring occasions of different SSSGs is different in sparsity.

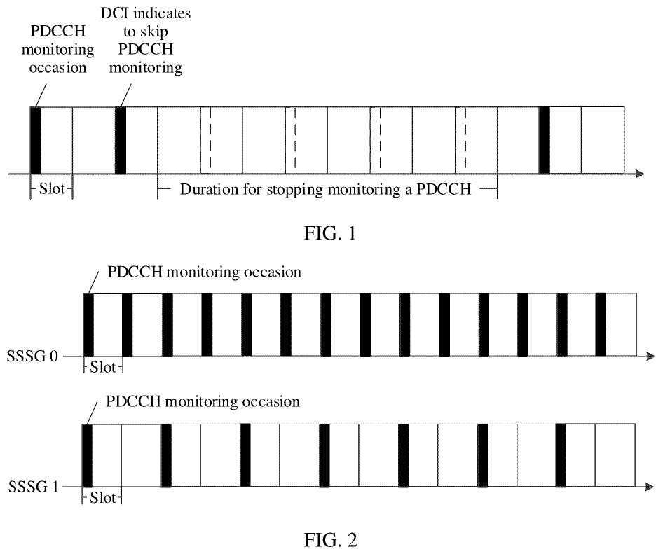

For example, the network device groups, based on configuration information of SS sets, the SS sets into two groups of SSSGs: the SSSG 0 and the SSSG 1. FIG. 2 is a schematic diagram of PDCCH monitoring periodicities of SS sets associated with the SSSG 0 and the SSSG 1. As shown in FIG. 2, on the PDCCH monitoring occasion of the SS set associated with the SSSG 0, one slot is used as a periodicity, to periodically monitor the PDCCH, and on the PDCCH monitoring occasion of the SS set associated with the SSSG 1, two slots are used as a periodicity, to periodically monitor the PDCCH. PDCCH monitoring occasions of the SSSG 1 are sparse compared with PDCCH monitoring occasions of the SSSG 0.

The terminal device monitors the PDCCH based on the SS set of the SSSG 0. After receiving information indicating that the network device indicates the terminal device to switch to the SSSG 1, the terminal device switches to the SSSG 1, and monitors the PDCCH based on the SS set of the SSSG1.

The terminal device switches to the SSSG 1 with the sparse PDCCH monitoring occasions, so that PDCCH monitoring is reduced, and power consumption of the terminal device is reduced.

The SSSG switching mechanism is applicable to a type 3 common search space set (CSS set) and a user equipment-specific search space set (USS set), that is, the USS set and the type 3 CSS set are grouped.

The terminal device implements dynamic SSSG switching, and the network device explicitly indicates or implicitly indicates, by using a bit field in the DCI or the DCI, the terminal device to perform SSSG switching.

For example, there are two search space set groups: the SSSG 0 and the SSSG 1, and explicit indication of the bit field in the DCI is: In response to the terminal device monitoring the PDCCH based on the SS set of the SSSG 1, and a field indicator in the received DCI being 0, the terminal device switches to the SSSG 0, that is, monitors the PDCCH based on the SS set of the SSSG 0, and stops monitoring the PDCCH based on the SS set of the SSSG 1. In response to the terminal device monitoring the PDCCH based on the SS set of the SSSG 0, and the field indicator in the received DCI being 1, the terminal device switches to the SSSG 1.

For implicit indication of the DCI, in at least one embodiment, in response to the terminal device monitoring the PDCCH based on the SS set of the SSSG1, and the terminal device detecting any DCI format or detects a specific DCI format, the terminal device switches to the SSSG 0. Alternatively, switching from the SSSG0 to the SSSG1 is performed in this manner.

In at least one embodiment, in response to the terminal device monitoring the PDCCH based on the SS set of the SSSG 1, the terminal device starts a timer used for SSSG switching. After the timer expires, the terminal device switches to the SSSG 0. Alternatively, switching from the SSSG0 to the SSSG1 is performed in this manner.

The network device configures both the search space set group (SSSG) switching mechanism and the PDCCH monitoring skipping mechanism. In this case, after stopping monitoring the PDCCH for a period of time, the terminal device monitors the PDCCH based on the SS set of one of the SSSGs.

### 3. BWP Switching Mechanism

For one cell, a network device configures a plurality of downlink (DL) BWPs and/or a plurality of uplink (UL) BWPs for a terminal device, and frequency domain resources of different BWPs overlap or do not overlap. At the same time, one DL BWP and one UL BWP are active in a cell.

For a time division duplex (TDD) scenario (or referred to as an unpaired spectrum scenario), DL BWPs and UL BWPs with a same ID are associated, and center frequencies of each pair of associated DL BWPs and UL BWPs are the same. In response to the DL BWP being switched, the UL BWP is also switched accordingly. In response to the UL BWP being switched, the UL BWP is also switched accordingly.

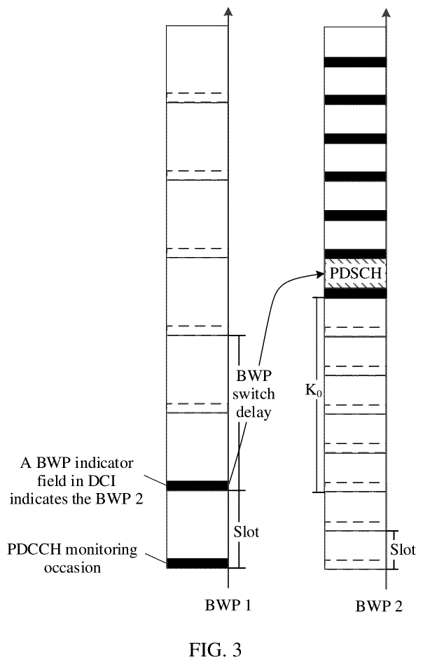

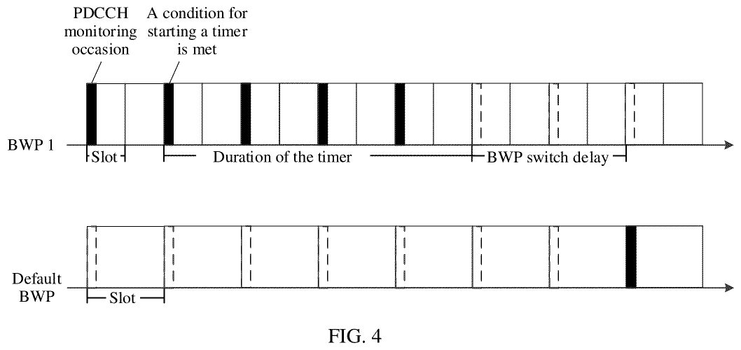

The BWP switching mechanism is implemented in two manners. In at least one embodiment, the network device dynamically switches the DL BWP or the UL BWP based on the PDCCH. For example, the network device dynamically switches the DL BWP based on the PDCCH. FIG. 3 is a schematic diagram of DL BWP switching. As shown in FIG. 3, the network device configures two BWPs: a BWP 1 and a BWP 2. A subcarrier spacing of the BWP 1 is 30 kilohertz (kHz), and a subcarrier spacing of the BWP 2 is 60 kHz. Currently, the BWP 1 is in an active state. In response to the terminal device detecting that a BWP indicator field in the DCI indicates the BWP 2, the terminal device performs BWP switching, and monitors a PDCCH on the BWP 2 after a BWP switch delay.

The DCI is further used to schedule a PDSCH, and the terminal device receives the PDSCH on the BWP 2 based on scheduling information of the DCI. A slot offset K₀ (namely, a slot offset between the PDCCH and the scheduled PDSCH) indicated by a time domain resource allocation field of the DCI is to be not less than the BWP switch delay. As shown in FIG. 3, K₀ is one slot more than the BWP switch delay, and the terminal device starts to receive the PDSCH on the BWP 2 in a slot corresponding to the slot offset K₀ indicated by the DCI, and continues to monitor the PDCCH. After an end symbol for the DCI and before the slot offset indicated by the DCI, the terminal device does not receive or send data, and the terminal device does not monitor the PDCCH.

Different subcarrier spacings correspond to different slot lengths. In FIG. 3, the BWP switch delay includes two slots, and the slot length is a slot length corresponding to a subcarrier spacing of 30 kHz. K₀ includes five slots, and the slot length is a slot length corresponding to a subcarrier spacing of 60 kHz. K₀ is one slot more than the BWP switch delay, and the slot length is the slot length corresponding to the subcarrier spacing of 60 kHz.

The BWP switch delay includes two slots and K₀ includes five slots is merely an example. This is not limited in at least one embodiment.

In at least one embodiment, the network device configures a timer for BWP switching (e.g. bwp-InactivityTimer) for the terminal device. The timer is used by the terminal device to roll back from a currently active BWP to a default BWP. The network device configures an identifier (ID) of the default BWP by using RRC signaling, and the terminal device rolls back from the currently active BWP to a BWP corresponding to the identifier of the default BWP. Alternatively, in response to the network device not configuring the identifier of the default BWP, the terminal device falls back to an initial BWP configured by the network device.

For example, FIG. 4 is a schematic diagram of another DL BWP switching. As shown in FIG. 4, the terminal device monitors a PDCCH on a currently active BWP 1, where a subcarrier spacing of a BWP 1 is 60 kHz. In response to a condition for starting or restarting a timer being met, the timer is started or restarted and runs. In response to the condition for restarting the timer not being met, the timer decreases in descending order per subframe or per half subframe. In response to the timer expiring (that is, the timer is 0), the terminal device performs BWP switching, and monitors a PDCCH on a default BWP after a BWP switch delay. A subcarrier spacing of the default BWP is 30 kHz. The terminal device does not monitor the PDCCH between BWP switch delays.

The subcarrier spacing of the BWP 1 is 60 kHz, and one subframe corresponds to four slots. In FIG. 4, a duration of the timer includes eight slots, that is, the duration of the timer is two milliseconds, namely, two subframes. In response to the timer running, the timer decreases in descending order per subframe or per half subframe until the timer expires.

In FIG. 4, that the duration of the timer includes six slots and the BWP switch delay includes four slots is merely an example. This is not limited in at least one embodiment.

Different BWPs correspond to different subcarrier spacings, and different subcarrier spacings correspond to different slot lengths. In FIG. 4, the subcarrier spacing of the BWP 1 is different from that of the default BWP. Therefore, a slot length corresponding to the BWP 1 is different from that corresponding to the default BWP.

A condition for starting or restarting a timer used for BWP switching in a cell 1 includes any one of the following.
(1) A terminal device receives, on an active BWP in the cell 1, a PDCCH that is scrambled by a C-RNTI or a CS-RNTI and that indicates downlink scheduling or uplink scheduling.
(2) The terminal device receives, in a cell other than the cell 1, a PDCCH that is scrambled by a C-RNTI or a CS-RNTI and that indicates downlink scheduling or uplink scheduling on an active BWP in the cell 1.

This condition is applicable to inter-carrier scheduling and TDD scenarios.
(3) The terminal device sends uplink semi-persistent scheduling or receives downlink semi-persistent scheduling in the cell 1.
(4) The terminal device receives a PDCCH that indicates BWP switching of the cell 1.

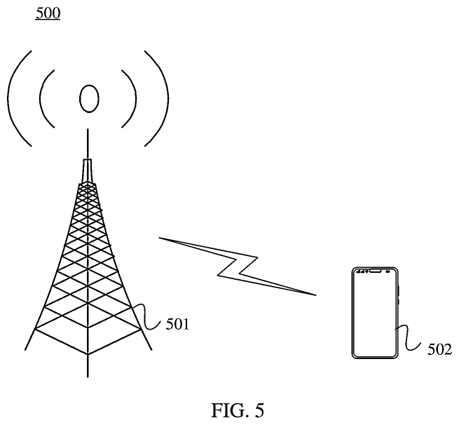

For ease of understanding embodiments described herein, a communication system applicable to at least one embodiment is first described in detail with reference to FIG. 5.

FIG. 5 is a schematic diagram of a communication system 500 according to at least one embodiment. As shown in FIG. 5, the communication system 500 includes a network device 501 and at least one terminal device 502. The network device 501 and the at least one terminal device 502 perform wireless communication. Specifically, the network device 501 sends, to the terminal device 502, a PDCCH that carries scheduling information of uplink data or downlink data, and the terminal device 502 periodically monitors the PDCCH to obtain the scheduling information.

In response to the terminal device 502 detecting that the PDCCH has the scheduling information, based on the scheduling information, the terminal device 502 receives the data through a PDSCH or sends data through a PUSCH. In many cases, the network device 501 does not constantly schedule data to the terminal device 502, but the terminal device 502 constantly periodically monitors the PDCCH to determine whether scheduling is performed. In response to there being no service transmission between the network device 501 and the terminal device 502, the network device 501 not sending a PDCCH to the terminal device 502. In response to the terminal device 502 still periodically monitoring the PDCCH, power consumption is increased. To reduce power consumption of the terminal device 502, one manner is to reduce unnecessary PDCCH monitoring.

Currently, in an active DL BWP, a network device uses the PDCCH monitoring skipping mechanism or the search space set group (SSSG) switching mechanism to reduce PDCCH monitoring, so as to reduce power consumption of a terminal device. For each cell, the network device configures a plurality of downlink BWPs and/or a plurality of uplink BWPs for the terminal device, and the network device dynamically switches an active BWP.

However, in response to both the PDCCH monitoring skipping mechanism and a BWP switching mechanism being configured for the terminal device, how the terminal device stops monitoring the PDCCH is not clearly defined.

For example, the network device indicates, based on DCI, the terminal device to stop monitoring a PDCCH in a period of time, and the terminal device stops monitoring the PDCCH in the period of time based on the DCI. The network device further configures a timer used for BWP switching for the terminal device, and starts the timer in response to a condition for starting the timer being met. The terminal device stops monitoring the PDCCH in this period of time. As a result, the condition for starting the timer is not met, and the timer is more likely to expire, resulting in frequent BWP switching.

For example, the network device indicates, based on DCI, the terminal device to stop monitoring a PDCCH in a period of time and perform BWP switching, and the terminal device performs BWP switching based on an indication of the DCI, and stops monitoring the PDCCH in the period of time. However, a start moment for stopping monitoring the PDCCH is not clearly defined currently.

In view of this, embodiments described herein provide a method for stopping monitoring a PDCCH and a communication apparatus. In response to a terminal device supporting both a PDCCH monitoring skipping mechanism and a BWP switching mechanism, time for stopping monitoring a PDCCH is specified, to help reduce power consumption of the terminal device.

For ease of understanding of embodiments described herein, the following several descriptions are provided.
1. In least one embodiment, “used for indication” includes “used for direct indication” and “used for indirect indication”, or includes “used for explicit indication” and “used for implicit indication”. Information indicated by a piece of information is referred to as to-be-indicated information. In a specific implementation process, the to-be-indicated information is indicated in a plurality of manners. By way of example but not limitation, the to-be-indicated information is directly indicated, for example, by using the to-be-indicated information or an index of the to-be-indicated information. Alternatively, the to-be-indicated information is indirectly indicated by indicating other information, and there is an association relationship between the other information and the to-be-indicated information. Alternatively, only a part of the to-be-indicated information is indicated, and the other part of the to-be-indicated information is known or pre-agreed on. For example, an agreement made in advance (for example, specified in a protocol) that the to-be-indicated information is to be indicated depending on whether an information element exists, thereby reducing indication overheads to some extent.
2. In the following embodiments, “first”, “second”, “third”, and various numbers are merely used for distinguishing for ease of description, and are not intended to limit the scope of embodiments described herein. For example, different downlink control information is distinguished.
3. In the following embodiments, “pre-definition” is a protocol definition. “Being predefined” is implemented by prestoring corresponding code or a corresponding table in a device (for example, including a terminal device and a network device) or in another manner that indicates related information. A specific implementation of “being predefined” is not limited in at least one embodiment.
4. A “protocol” in at least one embodiment is a standard protocol in the communication field, for example, includes a long term evolution (LTE) protocol, a new radio (NR) protocol, and a related protocol applied to a future communication system. This is not limited in at least one embodiment.

The following describes in detail embodiments provided herein.

In at least one embodiment, a terminal device and a network device are used as examples for description. The terminal device is replaced with an apparatus or a chip that implements a function similar to that of the terminal device, or the network device is replaced with an apparatus or a chip that implements a function similar to that of the network device. A name thereof is not limited in at least one embodiment.

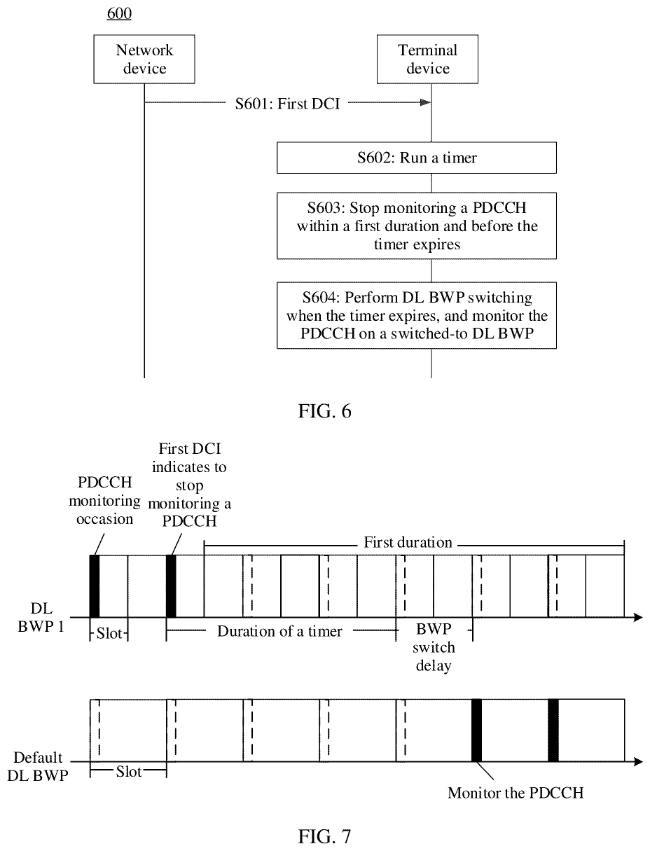

FIG. 6 is a schematic flowchart of a method 600 for stopping monitoring a PDCCH according to at least one embodiment. The method 600 is applied to the communication system 500 shown in FIG. 5. However, at least one embodiment is not limited thereto. As shown in FIG. 6, the method 600 includes the following steps.

S601: A network device sends first DCI to a terminal device on an active DL BWP, where the first DCI indicates the terminal device to stop monitoring a PDCCH within a first duration, and the PDCCH on which monitoring is stopped includes a PDCCH in a type 3 common search space set and a PDCCH in a terminal device-specific search space set. Correspondingly, the terminal device receives the first DCI on the active DL BWP.

The first DCI is carried on the PDCCH. The terminal device detects the first DCI on the PDCCH, stop, based on the first DCI, monitoring the PDCCH within the first duration, and continue to monitor the PDCCH after the first duration. The PDCCH on which monitoring is stopped includes the PDCCH in the type 3 common search space set and the PDCCH in the terminal device-specific search space set. For common search space sets of other types, for example, a type 0 common search space set, a type 0A common search space set, a type 1 common search space set, and a type 2 common search space set, the UE skips or not skip monitoring a PDCCH for DCI scrambled by a C-RNTI, an MCS-C-RNTI, or a CS-RNTI. This is not limited in at least one embodiment. For the type 0 common search space set, the type 0A common search space set, the type 1 common search space set, and the type 2 common search space set, whether the UE monitors an SI-RNTI, an RA-RNTI, a TC-RNTI, or a P-RNTI is not limited in at least one embodiment.

In response to a C-DRX mechanism being further configured for the terminal device, the first DCI indicates the terminal device to stop monitoring the PDCCH within the first duration in an active duration for C-DRX. In the active duration for the C-DRX, the terminal device stops monitoring the PDCCH within the first duration, and after the first duration, the terminal device continues to monitor the PDCCH in the active duration.

A unit of the first duration is a second, a millisecond, a frame, a subframe, a slot, a PDCCH monitoring periodicity, a quantity of PDCCH monitoring occasions, a slot set including several consecutive slots, or the like. This is not limited in at least one embodiment. For example, the first duration is eight slots, and the terminal device stops monitoring the PDCCH in the eight slots.

A start moment of the first duration is at the beginning of a slot in which the first DCI is located, at the beginning of a next slot for the first DCI, or at the beginning of a next symbol of an end symbol for the first DCI. This is not limited in at least one embodiment.

Optionally, a length of the first duration is configured by using RRC or indicated by the first DCI. A specific RRC configuration manner or a DCI indication manner is not limited in at least one embodiment.

For example, the network device sends the first DCI to the terminal device on the active DL BWP, where the first DCI indicates the terminal device to stop monitoring the PDCCH within the first duration, and indicates the length of the first duration.

For example, the network device sends the first DCI to the terminal device on the active DL BWP, where the first DCI indicates the terminal device to stop monitoring the PDCCH within the first duration. RRC signaling is sent to the terminal device on the active DL BWP. The RRC signaling indicates the length of the first duration.

Optionally, the length of the first duration is predefined in a protocol.

S602: The terminal device runs a timer, where the timer is used for BWP switching, and an expiration moment of the timer is earlier than an end moment of the first duration.

In a BWP switching process, that is, within a BWP switch delay, the terminal device does not monitor the PDCCH. Therefore, an alternative description is that the terminal device runs the timer, where the timer is used for BWP switching, and the expiration moment of the timer and the BWP switch delay are earlier than the end moment of the first duration. An end moment of the BWP switch delay is earlier than the end moment of the first duration.

A duration of the timer is configured by the network device by using RRC signaling or predefined in a protocol. A unit of the duration of the timer is a second, a millisecond, a frame, a subframe, a slot, or the like. This is not limited in at least one embodiment. For example, the duration of the timer is three milliseconds.

The terminal device starts and runs the timer before S601.

In response to a condition for starting or restarting the timer being met (for example, the first DCI includes scheduling information), the terminal device starts or restarts the timer and runs the timer, to be specific, the timer decreases in descending order per subframe or per half subframe. After the timer expires, the terminal device performs DL BWP switching. In response to the condition for restarting the timer being met before the timer expires, the timer is restarted, that is, the timer is started to run again.

For example, the duration of the timer is three milliseconds. After the timer is started or restarted, in response to the condition for starting or restarting the timer not being met, the terminal device runs the timer, to be specific, the timer decreases one subframe each time. In response to the timer showing 0, the terminal device performs DL BWP switching. In response to the timer showing two milliseconds, and the condition for restarting the timer being met, the timer shows three milliseconds again, and the timer decreases one subframe each time. The foregoing steps are repeated.

The expiration moment of the timer is earlier than the end moment of the first duration. For example, the first duration is greater than a duration within which the timer expires. For example, the first duration is greater than the duration within which the timer expires, the first duration is eight slots, and the duration of the timer is three milliseconds, namely, six slots.

A specific time location at which the timer is started or restarted is at the beginning of the slot in which the first DCI is located, at a start location of the next slot for the first DCI, or at a start location of the next symbol of the end symbol for the first DCI. This is not limited in at least one embodiment.

Correspondingly, the network device starts or restarts a timer and runs the timer.

S603: The terminal device stops monitoring the PDCCH within the first duration and before the timer expires.

The PDCCH on which monitoring is stopped includes the PDCCH in the type 3 common search space set and the PDCCH in the terminal device-specific search space set.

Correspondingly, the network device does not send the PDCCH to the terminal device within the first duration and before the timer expires, where the PDCCH includes the PDCCH in the type 3 common search space set and the PDCCH in the terminal device-specific search space set.

In the BWP switching process, that is, within the BWP switch delay, the terminal device does not monitor the PDCCH. Therefore, S603 alternatively is described as that, within the first duration, before the timer expires, and before the BWP switch delay, the terminal device stops monitoring the PDCCH. The terminal device stops monitoring the PDCCH within the first duration and before the BWP switch delay ends.

S604: The terminal device performs DL BWP switching in response to the timer expiring, and monitors the PDCCH on a switched-to DL BWP.

The end moment of the first duration is later than the expiration moment of the timer. In response to the timer expiring, a duration for stopping monitoring the PDCCH does not end, but the terminal device monitors the PDCCH on the switched-to DL BWP. The switched-to DL BWP is a new active DL BWP. The switched-to DL BWP is also referred to as a default DL BWP.

For example, FIG. 7 is a schematic diagram of stopping monitoring a PDCCH. As shown in FIG. 7, a block filled with a black pattern indicates a PDCCH monitoring occasion on which a terminal device performs monitoring. A network device configures a DL BWP 1 and a default DL BWP in a cell. A subcarrier spacing of the DL BWP 1 is 30 kHz, a duration of a timer is six slots, a first duration is 11 slots, the first duration is greater than the duration of the timer, a subcarrier spacing of the default DL BWP is 15 kHz, and a BWP switch delay is two slots. Different subcarrier spacings correspond to different slot lengths. Slot lengths included in the duration of the timer, the first duration, and the BWP switch delay are all slot lengths corresponding to a subcarrier spacing of 30 kHz. Quantities of slots included in the duration of the timer, the first duration, and the BWP switch delay are merely examples. This is not limited in at least one embodiment.

In response to the subcarrier spacing of the DL BWP 1 being 30 kHz, one subframe corresponds to two slots. In FIG. 7, the duration of the timer is six slots, that is, the duration of the timer is three subframes. In response to the timer running, the timer decreases in descending order per subframe or per half subframe until the timer expires.

The DL BWP 1 is a currently active BWP, and the terminal device monitors a PDCCH on the active DL BWP 1. The network device indicates, based on a PDCCH carrying the first DCI, the terminal device to stop monitoring the PDCCH within the first duration. The terminal device obtains, through monitoring, the PDCCH carrying the first DCI, and obtains an indication of the first DCI by detecting the PDCCH carrying the first DCI. As shown in FIG. 7, in response to a condition for starting or restarting the timer being met, the terminal device starts to run the timer from a slot in which the first DCI is located, and starts to stop monitoring the PDCCH from a next slot for the first DCI. In response to the timer expiring (after three subframes), the terminal device performs DL BWP switching. After the BWP switch delay (two slots), the terminal device switches to the default DL BWP to monitor the PDCCH.

In this case, a duration for stopping monitoring the PDCCH does not end. However, the terminal device monitors the PDCCH on the default DL BWP. The duration for stopping monitoring the PDCCH is terminated in advance.

Correspondingly, in response to the timer expiring, the network device performs DL BWP switching, and sends the PDCCH on a switched-to DL BWP. According to the method for stopping monitoring a PDCCH provided in at least one embodiment, the network device indicates the terminal device to stop monitoring the PDCCH within the first duration, and configures the timer used for BWP switching. The terminal device runs the timer and starts to stop monitoring the PDCCH, stops monitoring the PDCCH within the first duration and before the timer expires, and monitors the PDCCH on the switched-to BWP. In the method, the timer is run and PDCCH monitoring is started to be stopped, and running of the timer is not changed. Therefore, the impact on the protocol is low, and the implementation is simple. In the method for stopping monitoring a PDCCH provided in at least one embodiment, the BWP is switched in a timer manner, and default behavior of the terminal device on the switched-to BWP is PDCCH monitoring. Optionally, an SSSG is or is not configured on the switched-to DL BWP. A method for configuring the SSSG by the network device is not limited in this embodiment.

In response to no SSSG being configured on the switched-to BWP, the terminal device monitors the PDCCH on the switched-to BWP based on a configured SS set.

In response to SSSGs being configured on the switched-to BWP, the terminal device monitors the PDCCH based on an SS set of one of the SSSGs. For example, the network device configures SSSGs on the switched-to BWP. There are two SSSGs: an SSSG0 (that is, an index of the SSSG is 0) and an SSSG1 (that is, an index of the SSSG is 1). The terminal device monitors the PDCCH based on an SS set of the SSSG0 or an SS set of the SSSG1.

Optionally, there are three SSSGs: an SSSG0 (that is, an index of the SSSG is 0), an SSSG1 (that is, an index of the SSSG is 1), and an SSSG2 (that is, an index of the SSSG is 2). The terminal device monitors the PDCCH based on an SS set of the SSSG0, an SS set of the SSSG1, or an SS set of the SSSG2. In an implementation, the SSSG is configured on the switched-to BWP, and on the switched-to BWP, the terminal device monitors the PDCCH based on an SS set of an SSSG agreed in a protocol, where the SSSG agreed in the protocol is the SSSG0, the SSSG1, or the SSSG2. For example, the SSSG is configured on the switched-to BWP, and according to the protocol, the terminal device monitors the PDCCH on the switched-to BWP based on the SS set of the SSSG0. In another implementation, the network device configures one SSSG as an SSSG used by the terminal device to monitor the PDCCH on the switched-to BWP. For example, the SSSG configured by the network device is the SSSG0. In this case, the terminal device monitors the PDCCH on the switched-to BWP based on the SS set of the SSSG0.

Optionally, the active DL BWP is configured in a first cell, and the terminal device monitors the PDCCH on the active DL BWP of the first cell. The network device configures the duration of the timer in the first cell.

In response to there being a plurality of cells, the network device configures the duration of the timer in each of the plurality of cells.

The terminal device receives the first DCI on the active DL BWP of the first cell. The first DCI indicates the terminal device to stop monitoring the PDCCH within the first duration. In a scenario with the plurality of cells, the terminal device alternatively receives the first DCI on an active DL BWP of a cell other than the first cell. The first DCI indicates the terminal device to stop monitoring the PDCCH on the active DL BWP of the first cell. In addition, a duration for stopping monitoring the PDCCH is the first duration.

Optionally, the first DCI is further used to schedule transmission of a PDSCH or a PUSCH.

For example, the terminal device receives the first DCI on the active DL BWP of the first cell. The first DCI indicates the terminal device to stop monitoring the PDCCH within the first duration and is used to schedule the transmission of the PDSCH or the PUSCH. In the scenario with the plurality of cells, the terminal device alternatively receives the first DCI on the active DL BWP of the cell other than the first cell. The first DCI indicates the terminal device to stop monitoring the PDCCH on the active DL BWP of the first cell. In addition, the duration for stopping monitoring the PDCCH is the first duration. At the same time, the first DCI is used to schedule the transmission of the PDSCH or the PUSCH.

In response to the first DCI including the scheduling information, and the network device configuring the timer used for BWP switching, the terminal device starts to run the timer.

Optionally, the terminal device monitors the PDCCH based on an SS set configured on the active DL BWP. In response to a plurality of SSSGs being configured on the BWP, the terminal device monitors the PDCCH based on an SS set of one of the SSSGs. Therefore, in response to no SSSG being configured on the switched-to DL BWP, the terminal device performs DL BWP switching in response to the timer expiring, and monitors the PDCCH on the switched-to DL BWP based on the configured SS set. In other words, default behavior of the terminal device on the switched-to BWP is PDCCH monitoring based on the configured SS set. In response to the SSSGs being configured on the switched-to DL BWP, the terminal device performs DL BWP switching in response to the timer expiring, and monitoring the PDCCH on the switched-to DL BWP based on the SS set of one of the SSSGs. In other words, default behavior of the terminal device on the switched-to BWP is PDCCH monitoring based on the SS set of one of the SSSGs. The SSSG is agreed in a protocol, or is configured by the network device, and the SSSG is the SSSG0, the SSSG1, or the SSSG2. For example, the terminal device monitors the PDCCH on the switched-to BWP based on the SS set whose SSSG index is 0.

Optionally, in response to the network device initially configuring or reconfiguring a parameter for a PDCCH monitoring skipping mechanism and/or a parameter for an SSSG switching mechanism by using the RRC signaling, behavior of the terminal device on the active DL BWP is the same as that described above. In other words, in response to no SSSG being configured on the active DL BWP, the terminal device monitors the PDCCH on the active DL BWP based on the configured SS set. In other words, the default behavior of the terminal device on the active DL BWP is PDCCH monitoring based on the configured SS set. In response to the SSSGs being configured on the active DL BWP, the terminal device monitors the PDCCH on the active DL BWP based on the SS set of one of the SSSGs. In other words, default behavior of the terminal device on the active DL BWP is PDCCH monitoring based on the SS set of one of the SSSGs. The SSSG is agreed in a protocol, or is configured by the network device, and the SSSG is the SSSG0, the SSSG1, or the SSSG2. For example, the terminal device monitors the PDCCH on the active DL BWP based on the SS set whose SSSG index is 0.

In the method 600, the terminal device stops monitoring the PDCCH while running the timer. At least one embodiment further provides another method 800 for stopping monitoring a PDCCH. The method 800 is a parallel solution with the method 600. A terminal device stops running a timer while stopping monitoring a PDCCH.

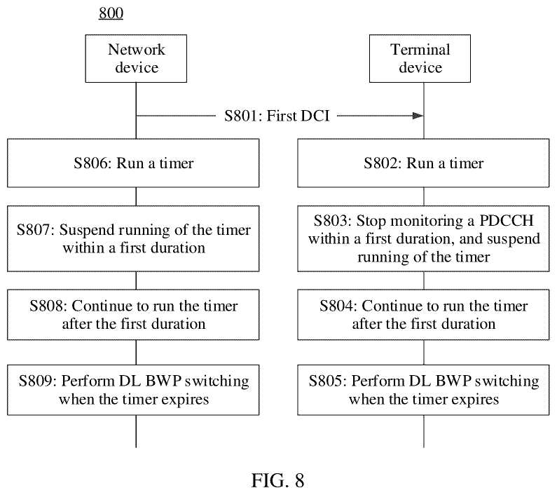

Specifically, FIG. 8 is a schematic flowchart of the another method 800 for stopping monitoring a PDCCH according to at least one embodiment. The method 800 is applied to the communication system 500 shown in FIG. 5. However, at least one embodiment is not limited thereto. As shown in FIG. 8, the method 800 includes the following steps.

S801: A network device sends first DCI to the terminal device on an active DL BWP, where the first DCI indicates the terminal device to stop monitoring the PDCCH within a first duration, and the PDCCH on which monitoring is stopped includes a PDCCH in a type 3 common search space set and a PDCCH in a terminal device-specific search space set. Correspondingly, the terminal device receives the first DCI on the active DL BWP. A start moment of the first duration is at the beginning of a slot in which the first DCI is located, at the beginning of a next slot for the first DCI, or at the beginning of a next symbol of an end symbol for the first DCI. This is not limited in at least one embodiment.

Optionally, a length of the first duration is configured by using RRC or indicated by the first DCI. A specific RRC configuration manner or a DCI indication manner is not limited in at least one embodiment.

For example, the network device sends the first DCI to the terminal device on the active DL BWP, where the first DCI indicates the terminal device to stop monitoring the PDCCH within the first duration, and indicates the length of the first duration.

For example, the network device sends the first DCI to the terminal device on the active DL BWP, where the first DCI indicates the terminal device to stop monitoring the PDCCH within the first duration. RRC signaling is sent to the terminal device on the active DL BWP. The RRC signaling indicates the length of the first duration.

Optionally, the length of the first duration is predefined in a protocol.

For this step, refer to S601 in the method 600. Details are not described herein again.

S802: The terminal device runs a timer, where the timer is used for BWP switching.

A duration of the timer is configured by the network device by using RRC signaling or predefined in a protocol. A unit of the duration of the timer is a second, a millisecond, a frame, a subframe, a slot, or the like. This is not limited in at least one embodiment. For example, the duration of the timer is three milliseconds.

The terminal device starts and runs the timer before S801.

In response to a condition for starting or restarting the timer being met (for example, the first DCI includes scheduling information), the terminal device starts or restarts the timer and runs the timer, to be specific, the timer decreases in descending order per subframe or per half subframe. After the timer expires, the terminal device performs DL BWP switching. In response to the condition for restarting the timer being met before the timer expires, the timer is restarted, that is, the timer is started to run again.

A specific time location at which the timer is started or restarted is at the beginning of the slot in which the first DCI is located, at a start location of the next slot for the first DCI, or at a start location of the next symbol of the end symbol for the first DCI. This is not limited in at least one embodiment.

Correspondingly, the network device starts or restarts a timer and runs the timer.

S803: The terminal device stops, based on the first DCI, monitoring the PDCCH within the first duration, and suspends running of the timer.

The terminal device suspends running of the timer within the duration for stopping monitoring the PDCCH, that is, within the duration for stopping monitoring the PDCCH, suspending of the timer decreases in descending order per subframe or per half subframe.

Optionally, the terminal device suspends the running of the timer from a slot or a subframe in which the first DCI is located, or stops the running of the timer from a next slot or a next subframe for the first DCI.

Optionally, the terminal device suspends the running of the timer from a start moment of the first duration.

S804: The terminal device continues to run the timer after the first duration. The terminal device suspends the running of the timer. After the first duration, the terminal device continues to run the timer, that is, the timer decreases in descending order per subframe or per half subframe. After the first duration, in response to the condition for restarting the timer being met, the terminal device restarts and runs the timer.

For example, the duration of the timer is three milliseconds. In response to the timer decreasing to two milliseconds, the terminal device receives the PDCCH carrying the first DCI, and stops monitoring the PDCCH based on the first DCI. In addition, the timer keeps a duration of two milliseconds. After the first duration, the terminal device continues to run the timer, and the timer decreases one subframe each time until the timer expires.

S805: The terminal device performs DL BWP switching in response to the timer expiring.

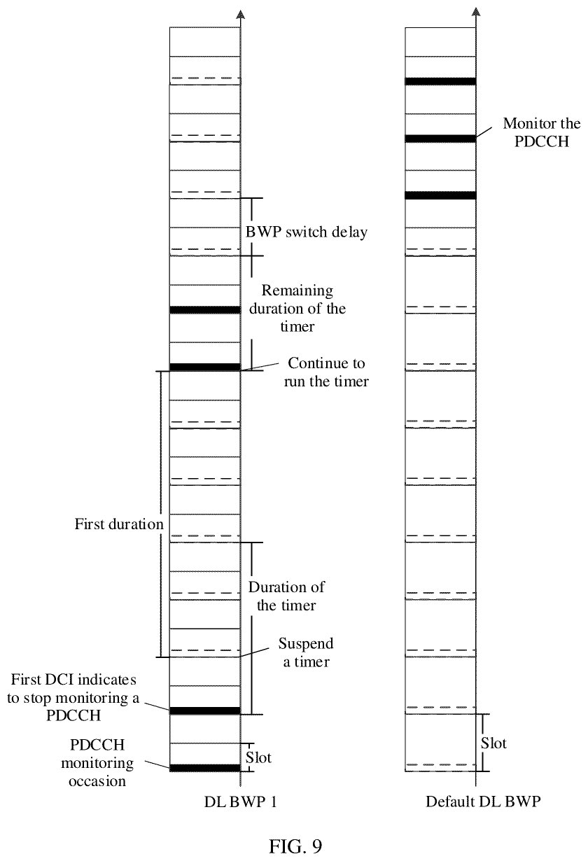

After performing DL BWP switching, the terminal device monitors the PDCCH on a switched-to DL BWP. The switched-to DL BWP is referred to as a default BWP. For example, FIG. 9 is a schematic diagram of stopping monitoring a PDCCH. As shown in FIG. 9, a block filled with a black pattern indicates a PDCCH monitoring occasion on which a terminal device performs monitoring. A network device configures a DL BWP 1 and a default DL BWP in a cell. A subcarrier spacing of the DL BWP 1 is 30 kHz, a duration of a timer is six slots, a first duration is 10 slots, a subcarrier spacing of the default DL BWP is 15 kHz, and a BWP switch delay is two slots. Different subcarrier spacings correspond to different slot lengths. Slot lengths included in the duration of the timer, the first duration, and the BWP switch delay are all slot lengths corresponding to a subcarrier spacing of 30 kHz. Quantities of slots included in the duration of the timer, the first duration, and the BWP switch delay are merely examples. This is not limited in at least one embodiment.

In response to the subcarrier spacing of the DL BWP 1 being 30 kHz, one subframe corresponds to two slots. In FIG. 9, the duration of the timer is six slots, that is, the duration of the timer is three subframes. In response to the timer running, the timer decreases in descending order per subframe or per half subframe until the timer expires.

The DL BWP 1 is a currently active BWP, and the terminal device monitors a PDCCH on the active DL BWP 1. The network device indicates, based on a PDCCH carrying the first DCI, the terminal device to stop monitoring the PDCCH within the first duration. The terminal device obtains, through monitoring, the PDCCH carrying the first DCI, and obtains an indication of the first DCI by detecting the PDCCH carrying the first DCI. As shown in FIG. 9, in response to a condition for starting or restarting the timer being met, the terminal device starts to run the timer from the slot in which the first DCI is located, where the timer decreases in descending order per subframe. At the same time, from a start moment of the first duration, PDCCH monitoring is stopped while running of the timer is suspended. In this case, the duration of the timer is four slots, namely, two subframes.

The terminal device stops monitoring the PDCCH in 10 slots. After the 10 slots, the terminal device continues to monitor the PDCCH and continues to run the timer. In this case, the timer decreases from two subframes in descending order per subframe until the timer expires. In response to the timer expiring, the terminal device performs DL BWP switching. After the BWP switch delay (two slots), the terminal device switches to the default DL BWP to monitor the PDCCH.

S806: The network device runs the timer.

The network device also correspondingly runs the timer while the terminal device runs the timer.

Optionally, according to the protocol, the terminal device and the network device run the timer at the same time.

S807: The network device suspends running of the timer within a first duration.

In response to the terminal device suspending the running of the timer within the first duration, the network device also suspends the running of the timer within the first duration.

Optionally, according to the protocol, the terminal device and the network device suspend the running of the timer within the first duration at the same time.

S808: The network device continues to run the timer after the first duration.

After the first duration, the network device also continues to run the timer while the terminal device runs the timer.

Optionally, according to the protocol, after the first duration, the terminal device and the network device simultaneously continue to run the timer.

S809: The network device performs DL BWP switching in response to the timer expiring.

In response to the timer expiring, the network device switches a BWP, and sends the PDCCH on a switched-to BWP, and the terminal device monitors the PDCCH on the switched-to BWP.

In at least one embodiment, S803 is: The terminal device stops, based on the first DCI, monitoring the PDCCH within the first duration, and terminates running of the timer. S804 is: After the first duration, the terminal device restarts and runs the timer. Correspondingly, in S807, the network device terminates running of the timer within the first duration. S808 is: After the first duration, the network device restarts and runs the timer.

According to the method for stopping monitoring a PDCCH provided in at least one embodiment, the network device indicates the terminal device to stop monitoring the PDCCH within the first duration, and configures the timer used for BWP switching. In response to stopping monitoring the PDCCH, the terminal device suspends running of the timer, and continues to run the timer after the first duration, that is, stopping monitoring the PDCCH and stopping running the timer are run in different time periods. This avoids a problem that the timer easily expires due to stopping monitoring the PDCCH. In addition, the terminal device stops monitoring the PDCCH within the first duration, to reduce power consumption of the terminal device.

Optionally, an SSSG is or is not configured on the switched-to DL BWP.

In response to no SSSG being configured on the switched-to BWP, the terminal device monitors the PDCCH on the switched-to BWP based on a configured SS set.

In response to SSSGs being configured on the switched-to BWP, the terminal device monitors the PDCCH based on an SS set of one of the SSSGs. For example, the network device configures SSSGs on the switched-to BWP. There are two SSSGs: an SSSG0 (that is, an index of the SSSG is 0) and an SSSG1 (that is, an index of the SSSG is 1). The terminal device monitors the PDCCH based on an SS set of the SSSG0 or an SS set of the SSSG1. Optionally, there are three SSSGs: an SSSG0 (that is, an index of the SSSG is 0), an SSSG1 (that is, an index of the SSSG is 1), and an SSSG2 (that is, an index of the SSSG is 2). The terminal device monitors the PDCCH based on an SS set of the SSSG0, an SS set of the SSSG1, or an SS set of the SSSG2. In an implementation, the SSSG is configured on the switched-to BWP, and on the switched-to BWP, the terminal device monitors the PDCCH based on an SS set of an SSSG agreed in a protocol, where the SSSG agreed in the protocol is the SSSG0, the SSSG1, or the SSSG2. For example, the SSSG is configured on the switched-to BWP, and according to the protocol, the terminal device monitors the PDCCH on the switched-to BWP based on the SS set of the SSSG0. In another implementation, the network device configures one SSSG as an SSSG used by the terminal device to monitor the PDCCH on the switched-to BWP. For example, the SSSG configured by the network device is the SSSG0. In this case, the terminal device monitors the PDCCH on the switched-to BWP based on the SS set of the SSSG0.

Optionally, in response to the network device initially configuring or reconfiguring a parameter for a PDCCH monitoring skipping mechanism and/or a parameter for an SSSG switching mechanism by using the RRC signaling, behavior of the terminal device on the active DL BWP is the same as that described above. In other words, in response to no SSSG being configured on the active DL BWP, the terminal device monitors the PDCCH on the active DL BWP based on the configured SS set. In other words, default behavior of the terminal device on the active DL BWP is PDCCH monitoring based on the configured SS set. In response to the SSSGs being configured on the active DL BWP, the terminal device monitors the PDCCH on the active DL BWP based on the SS set of one of the SSSGs. In other words, default behavior of the terminal device on the active DL BWP is PDCCH monitoring based on the SS set of one of the SSSGs. The SSSG is agreed in a protocol, or is configured by the network device, and the SSSG is the SSSG0, the SSSG1, or the SSSG2. For example, the terminal device monitors the PDCCH on the active DL BWP based on the SS set whose SSSG index is 0.

In the method 600 and the method 800, the terminal device runs the timer includes: The terminal device starts or restarts the timer in response to the terminal device receiving indication information from the network device on the active DL BWP. The indication information is used to schedule the terminal device to transmit a PDSCH or a PUSCH, or the indication information indicates the terminal device to perform DL BWP switching, and the indication information is carried in the first DCI or DCI other than the first DCI.

The indication information is carried in the first DCI, or is carried in the DCI different from the first DCI. This is not limited in at least one embodiment.

In at least one embodiment, the indication information is used to schedule the terminal device to transmit the PDSCH or the PUSCH, and is carried in first DCI. The first DCI is carried on a PDCCH scrambled by a C-RNTI or a CS-RNTI.

The terminal device receives, on an active DL BWP in a first cell, the PDCCH that carries the first DCI and that is scrambled by the C-RNTI, where the first DCI is used to schedule transmission of the PDSCH or the PUSCH, and the terminal device starts or restarts the timer. The terminal device receives, in a cell other than the first cell, a PDCCH that carries DCI other than the first DCI and that is scrambled by the C-RNTI, where the DCI indicates to transmit the PDSCH or the PUSCH on the active DL BWP in the first cell, and the terminal device starts or restarts the timer.

In at least one embodiment, the indication information indicates the terminal device to perform DL BWP switching, and the indication information is carried in DCI other than the first DCI.

The terminal device receives the DCI other than the first DCI, where the DCI other than the first DCI indicates the terminal device to perform DL BWP switching, and the terminal device performs BWP switching based on the DCI, and starts the timer on the switched-to BWP.

The start moment of the first duration is not clearly defined in the method 600 and the method 800. At least one embodiment provides a method 1000 for stopping monitoring a PDCCH, to specify the start moment of the first duration.

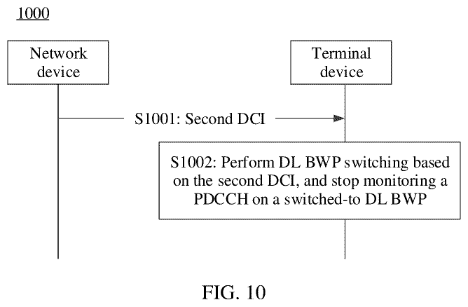

Specifically, FIG. 10 is a schematic flowchart of the still another method 1000 for stopping monitoring a PDCCH according to at least one embodiment. The method 1000 is applied to the communication system 500 shown in FIG. 5. However, at least one embodiment is not limited thereto. As shown in FIG. 10, the method 1000 includes the following steps.

S1001: A network device sends second DCI to a terminal device on an active DL BWP, where the second DCI indicates to perform DL BWP switching and stop monitoring a PDCCH within a first duration, the PDCCH on which monitoring is stopped includes a PDCCH in a type 3 common search space set and a PDCCH in a terminal device-specific search space set, and the second DCI is used to schedule transmission of a PDSCH. Correspondingly, the terminal device receives the second DCI on the active DL bandwidth part BWP.

The second DCI is carried on the PDCCH. The terminal device detects the second DCI

on the PDCCH on the active DL BWP, stops, based on the second DCI, monitoring the PDCCH within the first duration, and performs DL BWP switching. The PDCCH on which monitoring is stopped includes the PDCCH in the type 3 common search space set and the PDCCH in the terminal device-specific search space set. For common search space sets of other types, for example, a type 0 common search space set, a type 0A common search space set, a type 1 common search space set, and a type 2 common search space set, the UE skips or not skip monitoring a PDCCH for DCI scrambled by a C-RNTI, an MCS-C-RNTI, or a CS-RNTI. This is not limited in at least one embodiment. For the type 0 common search space set, the type 0A common search space set, the type 1 common search space set, and the type 2 common search space set, whether the UE monitors an SI-RNTI, an RA-RNTI, a TC-RNTI, or a P-RNTI is not limited in at least one embodiment.

A BWP indicator field in the second DCI indicates DL BWP switching, and indicates to stop monitoring the PDCCH within the first duration and schedule the transmission of the PDSCH. Specifically, the second DCI carries scheduling information of the PDSCH, and the BWP indicator field in the second DCI indicates an ID of a DL BWP. The ID is different from an ID of the currently active DL BWP. The terminal device switches to the DL BWP in the indicator field in the second DCI based on the second DCI.

A start moment of the first duration is at the beginning of a slot in which first DCI is located, at a start location of a next slot for the first DCI, or at a start location of a next symbol of an end symbol for the first DCI. This is not limited in at least one embodiment.

Optionally, a length of the first duration is configured by using RRC or indicated by the first DCI. A specific RRC configuration manner or a DCI indication manner is not limited in at least one embodiment.

For example, the network device sends the second DCI to the terminal device on the active DL BWP, where the second DCI indicates the terminal device to stop monitoring the PDCCH within the first duration, and indicates the length of the first duration.

For example, the network device sends the second DCI to the terminal device on the active DL BWP, where the second DCI indicates the terminal device to stop monitoring the PDCCH within the first duration. RRC signaling is sent to the terminal device on the active DL BWP. The RRC signaling indicates the length of the first duration.

Optionally, the length of the first duration is predefined in a protocol.

S1002: The terminal device performs DL BWP switching based on the second DCI, and stops monitoring the PDCCH on a switched-to DL BWP. The start moment of the first duration is determined based on at least one of the following information: a next slot after a BWP switch delay; a slot in which the PDSCH is transmitted on the switched-to DL BWP; a slot next to a slot in which the PDSCH is transmitted on the switched-to DL BWP; a time offset between the start moment of the first duration and the second DCI; a maximum value between a minimum slot offset and a duration for parsing the second DCI, where the minimum slot offset is a minimum slot offset between a PDCCH carrying the second DCI and a PDSCH that is allowed to be scheduled by using the second DCI; or a moment after a HARQ corresponding to a PDSCH is fed back in response to the PDSCH being scheduled by using the second DCI.

The start moment of the first duration is in the next slot after the BWP switch delay, in the slot in which the PDSCH is transmitted on the switched-to DL BWP, or in the slot next to the slot in which the PDSCH is transmitted on the switched-to DL BWP. Being in the slot next to the slot in which the PDSCH is transmitted on the switched-to DL BWP alternatively is understood as being the slot next to the slot in which the PDSCH is transmitted on the switched-to DL BWP.

The start moment of the first duration is determined based on at least one of the time offset between the start moment of the first duration and the second DCI, the maximum value between the minimum slot offset and the duration for parsing the second DCI, or the moment after the HARQ corresponding to the PDSCH is fed back in response to the PDSCH being scheduled by using the second DCI. For ease of description, the start moment of the first duration that is determined in one of these manners is denoted as a start moment 2 of the first duration.

According to the method for stopping monitoring a PDCCH provided in at least one embodiment, in response to the start moment of the first duration being in the next slot after the BWP switch delay, in the slot in which the PDSCH is transmitted on the switched-to DL BWP, or in the slot next to the slot in which the PDSCH is transmitted on the switched-to DL BWP, there is no overlap between the first duration and the BWP switch delay. This helps the terminal device stop monitoring the PDCCH for a long time, and helps reduce power consumption of the terminal device. In addition, the start moment of the first duration is determined based on at least one of the time offset between the start moment of the first duration and the second DCI, the maximum value between the minimum slot offset and the duration for parsing the second DCI, or the moment after the hybrid automatic repeat request (HARQ) corresponding to the PDSCH is fed back in response to the PDSCH being scheduled by using the second DCI, and whether the first duration and the BWP switch delay overlap is capable of not being considered. The start moment of the first duration in a BWP switching scenario is determined in a manner the same as a manner of determining the start moment of the first duration in a BWP scenario. This reduces complexity of processing by the terminal device.

The following separately describes in detail at least one embodiment for the start moment of the first duration.

In at least one embodiment, the start moment of the first duration is in the next slot after the BWP switch delay.

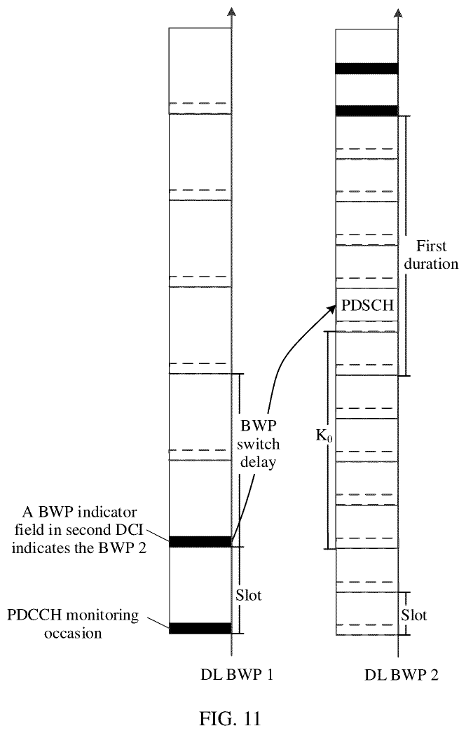

For example, FIG. 11 is a schematic diagram of stopping monitoring a PDCCH. As shown in FIG. 11, a block filled with a black pattern indicates a PDCCH monitoring occasion on which a terminal device performs monitoring. A network device configures a DL BWP 1 and a DL BWP 2 in a cell. A subcarrier spacing of the DL BWP 1 is 30 kHz, a BWP switch delay is two slots, a subcarrier spacing of the DL BWP 2 is 60 kHz, a first duration is six slots, and a slot offset K₀ between a PDCCH carrying the second DCI and a PDSCH scheduled by using the second DCI is five slots. K₀ is greater than or equal to the BWP switch delay. Different subcarrier spacings correspond to different slot lengths. Lengths of slots included in the first duration and K₀ are a slot length corresponding to a subcarrier spacing of the switched-to BWP, that is, a slot length corresponding to a subcarrier spacing of 60 kHz. A length of a slot included in the BWP switch delay is a slot length corresponding to a subcarrier spacing of 30 kHz. It should be further understood that quantities of slots included in the first duration, K₀, and the BWP switch delay are merely examples. This is not limited in at least one embodiment.

The DL BWP 1 is a currently active BWP, and the terminal device monitors a PDCCH on the active DL BWP 1. The terminal device detects that a BWP indicator field in the second DCI indicates the DL BWP 2, the second DCI indicates the terminal device to stop monitoring the PDCCH within the first duration, and the second DCI is used to schedule transmission of the PDSCH. As shown in FIG. 11, the terminal device transmits, based on the second DCI, the PDSCH on the DL BWP 2 after the slot offset K₀ (five slots), starts to stop monitoring the PDCCH from a next slot of the BWP switch delay, and starts to monitor the PDCCH after the first duration (six slots). After the slot offset K₀ (five slots) is replaced with during the slot offset K₀ (five slots). The terminal device transmits, based on the second DCI, the PDSCH on the DL BWP 2 during the slot offset K₀ (five slots) in a slot corresponding to the slot offset K₀.

In at least one embodiment, the start moment of the first duration is in the slot in which the PDSCH is transmitted on the switched-to DL BWP.

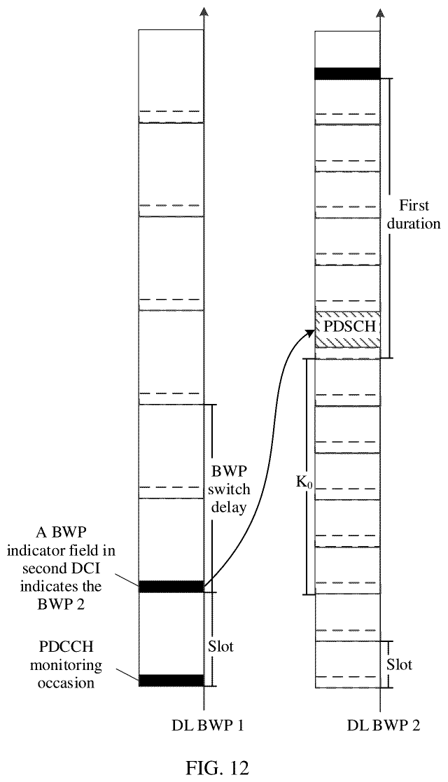

For example, FIG. 12 is another schematic diagram of stopping monitoring a PDCCH. As shown in FIG. 12, a block filled with a black pattern indicates a PDCCH monitoring occasion on which a terminal device performs monitoring. A network device configures a DL BWP 1 and a DL BWP 2 in a cell. A subcarrier spacing of the DL BWP 1 is 30 kHz, a BWP switch delay is two slots, a subcarrier spacing of the DL BWP 2 is 60 kHz, a first duration is six slots, and a slot offset K₀ between a PDCCH carrying the second DCI and a PDSCH scheduled by using the second DCI is five slots. K₀ is greater than the BWP switch delay. Different subcarrier spacings correspond to different slot lengths. Lengths of slots included in the first duration and K₀ are a slot length corresponding to a subcarrier spacing of 60 kHz. A length of a slot included in the BWP switch delay is a slot length corresponding to a subcarrier spacing of 30 kHz. Quantities of slots included in the first duration, K₀, and the BWP switch delay are merely examples. This is not limited in at least one embodiment.

The DL BWP 1 is a currently active BWP, and the terminal device monitors a PDCCH on the active DL BWP 1. The terminal device detects that a BWP indicator field in the second DCI indicates the DL BWP 2, the second DCI indicates the terminal device to stop monitoring the PDCCH within the first duration, and the second DCI is used to schedule transmission of the PDSCH. As shown in FIG. 12, the terminal device transmits, based on the second DCI, the PDSCH on the DL BWP 2 after the slot offset K₀ (five slots), starts to stop monitoring the PDCCH from a slot in which the PDSCH is transmitted on the DL BWP 2, and starts to monitor the PDCCH after the first duration (six slots). After the slot offset K₀ (five slots) is replaced with during the slot offset K₀ (five slots). The terminal device transmits, based on the second DCI, the PDSCH on the DL BWP 2 during the slot offset K₀ (five slots) in a slot corresponding to the slot offset K₀, and starts to stop monitoring the PDCCH from the slot in which the PDSCH is transmitted on the DL BWP 2.

In response to the PDSCH scheduled by using the second DCI occupying a plurality of slots, the start moment of the first duration is at the beginning of a first slot of the plurality of slots occupied by the PDSCH. Data transmitted on the PDSCH that occupies the plurality of slots is repeatedly sent on a same transport block or sent on different transport blocks.

In at least one embodiment, the start moment of the first duration is in the slot next to the slot in which the PDSCH is transmitted on the switched-to DL BWP.

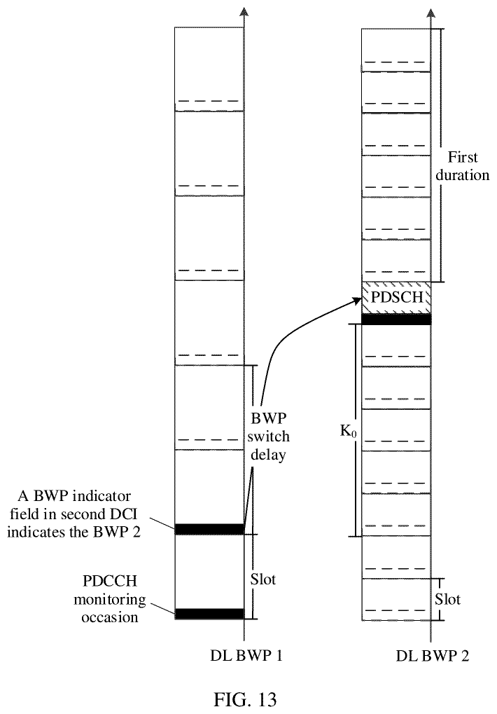

For example, FIG. 13 is still another schematic diagram of stopping monitoring a PDCCH. As shown in FIG. 13, a block filled with a black pattern indicates a PDCCH monitoring occasion on which a terminal device performs monitoring. A network device configures a DL BWP 1 and a DL BWP 2 in a cell. A subcarrier spacing of the DL BWP 1 is 30 kHz. In this case, a BWP switch delay is two slots 1. A subcarrier spacing of the DL BWP 2 is 60 kHz. In this case, a first duration is six slots 2. A slot offset K₀ between a PDCCH carrying the second DCI and a PDSCH scheduled by using the second DCI is five slots 2. K₀ is greater than the BWP switch delay. Different subcarrier spacings correspond to different slot lengths. Lengths of slots included in the first duration and K₀ are a slot length corresponding to a subcarrier spacing of 60 kHz. A length of a slot included in the BWP switch delay is a slot length corresponding to a subcarrier spacing of 30 kHz. Quantities of slots included in the first duration, K₀, and the BWP switch delay are merely examples. This is not limited in at least one embodiment.

The DL BWP 1 is a currently active BWP, and the terminal device monitors a PDCCH on the active DL BWP 1. The terminal device detects that a BWP indicator field in the second DCI indicates the DL BWP 2, the second DCI indicates the terminal device to stop monitoring the PDCCH within the first duration, and the second DCI is used to schedule transmission of the PDSCH. As shown in FIG. 13, the terminal device transmits, based on the second DCI, the PDSCH on the DL BWP 2 after the slot offset K₀ (five slots), starts to stop monitoring the PDCCH from a slot next to a slot in which the PDSCH is transmitted on the DL BWP 2, and starts to monitor the PDCCH after the first duration (six slots). After the slot offset K₀ (five slots) is replaced with during the slot offset K₀ (five slots). The terminal device transmits, based on the second DCI, the PDSCH on the DL BWP 2 during the slot offset K₀ (five slots) in a slot corresponding to the slot offset K₀, and starts to stop monitoring the PDCCH from the slot next to the slot in which the PDSCH is transmitted on the DL BWP 2.

In response to the PDSCH scheduled by using the second DCI occupying a plurality of slots, the start moment of the first duration is a slot next to a first slot of the plurality of slots occupied by the PDSCH, or a slot next to the end of the plurality of slots occupied by the PDSCH. Data transmitted on the PDSCH that occupies the plurality of slots is repeatedly sent on a same transport block or sent on different transport blocks.

In at least one embodiment, the start moment of the first duration is the time offset between the start moment of the first duration and the second DCI.

The time offset between the start moment of the first duration and the second DCI is predefined, or is configured by the network device by using RRC signaling.

The time offset between the start moment of the first duration and the second DCI is predefined. A unit of the time offset between the start moment of the first duration and the second DCI is a symbol or a slot.

Different BWPs have different subcarrier spacings. The protocol predefines that different subcarrier spacings correspond to different time offsets, or the protocol predefines that different subcarrier spacings correspond to a same time offset. The time offset between the start moment of the first duration and the second DCI is based on a slot offset corresponding to a subcarrier spacing corresponding to the currently active DL BWP, or based on a slot offset corresponding to a subcarrier spacing corresponding to the switched-to DL BWP.

For example, the time offset between the start moment of the first duration and the second DCI is greater than or equal to 0.

For example, the protocol predefines that different subcarrier spacings correspond to a same time offset. Table 1 shows a correspondence between a subcarrier spacing and a time offset.

TABLE 1

| Subcarrier spacing μ (kHz) | Time offset (symbol) |
|---|---|
| 15 | 25 |
| 30 | 25 |
| 60 | 25 |
| 120 | 25 |

As shown in Table 1, the subcarrier spacing is 15 kHz, 30 kHz, 60 kHz, or 120 kHz, and different subcarrier spacings correspond to a same time offset, namely, 25 symbols.

For example, the protocol predefines that different subcarrier spacings correspond to different time offsets. Table 2 shows the correspondence between the subcarrier spacing and the time offset.

Table 2 shows another correspondence between a subcarrier spacing and a time offset.

TABLE 2

| Subcarrier spacing μ (kHz) | Time offset (symbol) |
|---|---|
| 15 | 10 |
| 30 | 12 |
| 60 | 22 |
| 120 | 25 |

As shown in Table 2, the subcarrier spacing is 15 kHz, 30 kHz, 60 kHz, or 120 kHz. Different subcarrier spacings correspond to different time offsets. In response to the subcarrier spacing being 15 kHz, the time offset is 10 symbols. In response to the subcarrier spacing being 30 kHz, the time offset is 12 symbols. In response to the subcarrier spacing being 60 kHz, the time offset is 22 symbols. In response to the subcarrier spacing being 120 kHz, the time offset is 25 symbols.

The time offset shown in Table 1 and Table 2 is in a unit of a symbol, and the time offset is also in a unit of a slot.

For example, Table 3 shows another correspondence between a subcarrier spacing and a time offset.

TABLE 3

| Subcarrier spacing μ (kHz) | Time offset (slot) |
|---|---|
| 15 | 1 |
| 30 | 1 |
| 60 | 2 |
| 120 | 2 |

As shown in Table 2, the subcarrier spacing is 15 kHz, 30 kHz, 60 kHz, or 120 kHz. In response to the subcarrier spacing being 15 kHz or 30 kHz, the time offset is one slot. In response to the subcarrier spacing being 60 kHz or 120 kHz, the time offset is two slots.

The correspondences between the subcarrier spacings and the time offsets shown in Table 1, Table 2, and Table 3 are merely examples. This is not limited in at least one embodiment.

The start moment of the first duration is determined based on a time offset between the start moment of the first duration and the beginning of a symbol in which the second DCI is located, or the start moment of the first duration is determined based on a time offset between the start moment of the first duration and the end of the symbol occupied by the second DCI. In response to the moment determined based on the time offset not being the beginning of a slot, the start moment of the first duration is the beginning of a next slot of the time offset.

For example, the second DCI occupies three symbols, the time offset between the start moment of the first duration and the second DCI is 25 symbols, and a first symbol occupied by the second DCI is a first symbol of the 25 symbols, or a fourth symbol after a third symbol occupied by the second DCI is a first symbol of the 25 symbols.

The start moment of the first duration is determined based on a time offset between the start moment of the first duration and the beginning of a slot in which the second DCI is located, or the start moment of the first duration is determined based on a time offset between the start moment of the first duration and the end of a slot in which the second DCI is located.

For example, a slot occupied by the second DCI is one slot, the time offset between the start moment of the first duration and the second DCI is one slot, and the slot occupied by the second DCI is the slot of the time offset, or a slot next to the slot in which the second DCI is located is the slot of the time offset.

In at least one embodiment, the terminal device determines the start moment of the first duration based on the maximum value between the minimum slot offset and the duration for parsing the second DCI. The minimum slot offset is a minimum slot offset between a PDCCH carrying the second DCI and a PDSCH that is allowed to be scheduled by using the second DCI.

The minimum slot offset is represented by K₀ₘᵢₙ, and a value range of K₀ₘᵢₙ is a value greater than or equal to 0. The maximum value between the minimum slot offset and the duration for parsing the second DCI is represented as max(K₀ₘᵢₙ, Z), and the duration for parsing the second DCI is Z. For a specific subcarrier spacing, Z is a constant. For a value of Z, refer to Table 3.

Optionally, in a cross-carrier scheduling scenario, the terminal device determines the time offset between the start moment of the first duration and the second DCI according to a formula

$$max ( [ {K}_{0 min} * \frac{{2}^{μ PDCCH}}{{2}^{μ PDSCH}} ] , {Z}_{μ} ) \cdot {K}_{0 min}$$

is valid K₀ₘᵢₙ on an active DL BWP of a scheduled cell, Z_{μ} is a value corresponding to Z_{μ} of an active DL BWP of a scheduling cell (for a value of Z_{μ}, refer to Table 3), μPDCCH is a subcarrier spacing parameter of the active DL BWP of the scheduling cell, and μPDSCH is a subcarrier spacing parameter of the active DL BWP of the scheduled cell.

The foregoing implementation ensures that the terminal device stops monitoring the PDCCH after obtaining information about the second DCI through parsing, which helps improve communication efficiency between the terminal device and the network device.

In at least one embodiment, the start moment of the first duration is a moment after a HARQ corresponding to a PDSCH is fed back in response to the PDSCH being scheduled by using the second DCI.

HARQ feedbacks includes an acknowledgement (ACK) feedback or a negative acknowledgement (NACK) feedback.

After receiving the PDSCH, the terminal device further performs ACK feedback or NACK feedback. The start moment of the first duration is after the terminal device feeds back an ACK or a NACK. The second DCI indicates a slot in which the HARQ feedback is located.

Optionally, the start moment of the first duration is the beginning of a slot in which the terminal device transmits the ACK or the NACK or the beginning of a slot next to a slot in which the terminal device transmits the ACK or the NACK. The start moment of the first duration is the beginning or end of a symbol on which the terminal device transmits the ACK or the NACK.

Optionally, the terminal device stops monitoring the PDCCH within the first duration only in response to the terminal device feeding back the ACK. The start moment of the first duration is after the terminal device feeds back the ACK. Optionally, the start moment of the first duration is the beginning of a slot in which the terminal device transmits the ACK or the beginning of a slot next to a slot in which the terminal device transmits the ACK. The start moment of the first duration is the beginning or end of a symbol on which the terminal device transmits the ACK.

In the foregoing implementation, the terminal device starts to stop monitoring the PDCCH after performing PDSCH transmission, which helps implement communication between the terminal device and the network device.

Optionally, the start moment of the first duration alternatively is a moment later than that determined in at least two of the first implementation to the sixth implementation. For example, the start moment of the first duration is a moment later than that determined in at least one of the first implementation to the third implementation and that determined in at least one of the fourth implementation to the sixth implementation.

For example, the BWP switch delay in the first implementation is compared with the time offset in the fourth implementation, and the start moment of the first duration is determined based on a larger one of the two. For another example, the BWP switch delay in the first implementation is compared with the maximum value between and the minimum slot offset and the duration for parsing the second DCI in the fifth implementation, and the start moment of the first duration is determined based on a larger one of the two. For another example, the BWP switch delay in the first implementation is compared with an ACK or NACK feedback moment in the sixth implementation, and the start moment of the first duration is determined based on a larger one of the two. For another example, the slot offset K₀ (used to indicate the slot in which the PDSCH is transmitted on the switched-to DL BWP) of the PDSCH indicated by the second DCI in the second implementation is compared with the time offset in the fourth implementation, and the start moment of the first duration is determined based on a larger one of the two. For another example, the slot offset K₀ (used to indicate the slot in which the PDSCH is transmitted on the switched-to DL BWP) of the PDSCH indicated by the second DCI in the second implementation is compared with the maximum value between the minimum slot offset and the duration for parsing the second DCI in the fifth implementation, and the start moment of the first duration is determined based on a larger one of the two. For another example, the slot offset K₀ of the PDSCH indicated by the second DCI in the second implementation is compared with an ACK or NACK feedback moment in the sixth implementation, and the start moment of the first duration is determined based on a larger one of the two. Generally, a symbol location for transmitting the ACK or the NACK is after the symbol location for transmitting the PDSCH, and the slot for transmitting the ACK or the NACK and the slot for transmitting the PDSCH is a same slot, or is different slots.

In response to the start moment of the first duration being later than an end moment of the BWP switch delay, or the start moment of the first duration is after the slot in which the PDSCH scheduled by using the second DCI is transmitted on the switched-to DL BWP, behavior of monitoring the PDCCH by the terminal device after the BWP switch delay and before the start moment of the first duration includes:

In response to no SSSG being configured on the switched-to BWP, the terminal device monitors the PDCCH on the switched-to BWP based on a configured SS set; or
when SSSGs are configured on the switched-to BWP, the terminal device monitors the PDCCH based on an SS set of one of the SSSGs. For example, the network device configures SSSGs on the switched-to BWP. There are two SSSGs: an SSSG0 (that is, an index of the SSSG is 0) and an SSSG1 (that is, an index of the SSSG is 1). The terminal device monitors the PDCCH based on an SS set of the SSSG0 or an SS set of the SSSG1.

Optionally, there are three SSSGs: an SSSG0 (that is, an index of the SSSG is 0), an SSSG1 (that is, an index of the SSSG is 1), and an SSSG2 (that is, an index of the SSSG is 2). The terminal device monitors the PDCCH based on an SS set of the SSSG0, an SS set of the SSSG1, or an SS set of the SSSG2.

In an implementation, the SSSG is configured on the switched-to BWP, and on the switched-to BWP, the terminal device monitors the PDCCH based on an SS set of an SSSG agreed in a protocol, where the SSSG agreed in the protocol is the SSSG0, the SSSG1, or the SSSG2. For example, the SSSG is configured on the switched-to BWP, and according to the protocol, the terminal device monitors the PDCCH on the switched-to BWP based on the SS set of the SSSG0. In another implementation, the network device configures one SSSG as an SSSG used by the terminal device to monitor the PDCCH on the switched-to BWP. For example, the SSSG configured by the network device is the SSSG0. In this case, the terminal device monitors the PDCCH on the switched-to BWP based on the SS set of the SSSG0. On the switched-to BWP, the terminal device starts to monitor the PDCCH from the slot in which the PDSCH scheduled by using the second DCI is located. Therefore, the behavior of monitoring the PDCCH by the terminal device after the BWP switch delay and before the start moment of the first duration includes the foregoing method. The behavior of monitoring the PDCCH by the terminal device before the start moment of the first duration and from the slot in which the PDSCH scheduled by using the second DCI is located includes the foregoing method.

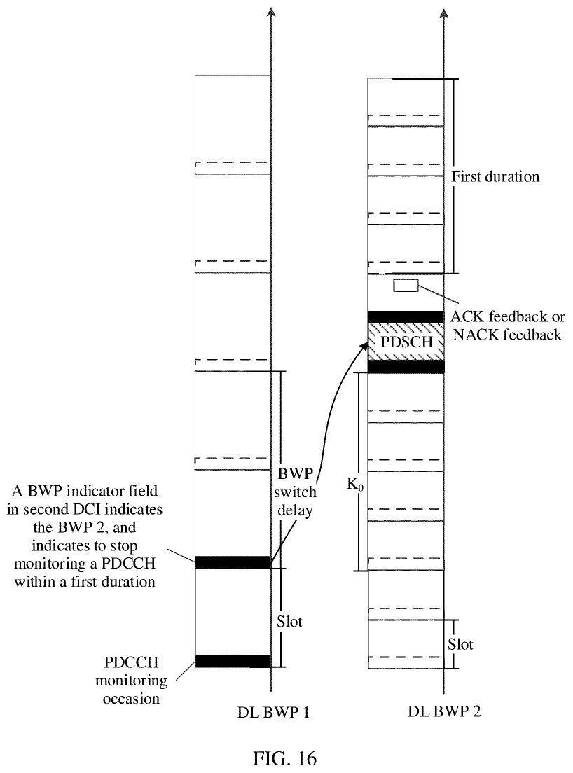

For example, FIG. 16 is a schematic diagram of stopping monitoring a PDCCH. As shown in FIG. 16, a block filled with a black pattern indicates a PDCCH monitoring occasion on which a terminal device is to perform monitoring. A network device configures a DL BWP 1 and a DL BWP 2 in a cell. A subcarrier spacing of the DL BWP 1 is 30 kHz, a BWP switch delay is two slots, a subcarrier spacing of the DL BWP 2 is 60 kHz, and a slot offset K₀ between a PDCCH carrying the second DCI and a PDSCH scheduled by using the second DCI is four slots. K₀ is greater than or equal to the BWP switch delay. Different subcarrier spacings correspond to different slot lengths. Lengths of slots included in the first duration and K₀ are a slot length corresponding to a subcarrier spacing of the switched-to BWP, that is, a slot length corresponding to a subcarrier spacing of 60 kHz. A length of a slot included in the BWP switch delay is a slot length corresponding to a subcarrier spacing of 30 kHz. Quantities of slots included in the first duration, K₀, and the BWP switch delay are merely examples. This is not limited in at least one embodiment.

The DL BWP 1 is a currently active BWP, and the terminal device monitors a PDCCH on the active DL BWP 1. The terminal device detects that a BWP indicator field in the second DCI indicates the DL BWP 2 and indicates to stop monitoring the PDCCH within the first duration. In addition, the second DCI is used to schedule transmission of the PDSCH. In addition, the terminal device is to perform ACK or NCK feedback to the network device. A start moment of the first duration is after an ACK or NACK feedback duration. The ACK or the ACK in the figure only indicates that a time sequence is after the PDSCH, and does not indicate that the ACK or the NACK and the PDSCH are on a same BWP.

As shown in FIG. 16, the terminal device transmits, based on the second DCI, the PDSCH on the DL BWP 2 after the BWP switch delay (two slots), and performs ACK or NCK feedback.

In response to no SSSG being configured on the DL BWP 2, after the BWP switch delay and before the start moment of the first duration, the terminal device monitors the PDCCH based on a configured SS set.

For the method 1000, in response to a parameter for an SSSG switching mechanism and/or a parameter for a PDCCH monitoring skipping mechanism not being configured on the active DL BWP, in response to no bit field in the second DCI indicating to perform SSSG switching and/or skip PDCCH monitoring within the first duration, the second DCI indicates to perform DL BWP switching, but does not indicate to perform SSSG switching and/or skip PDCCH monitoring within the first duration.

The terminal device receives the second DCI on the active DL BWP, performs DL BWP switching, and monitors the PDCCH on the switched-to DL BWP.

That the terminal device monitors the PDCCH on the switched-to DL BWP includes:

In response to no SSSG being configured on the switched-to BWP, the terminal device monitors the PDCCH on the switched-to BWP based on a configured SS set; or
when SSSGs are configured on the switched-to BWP, the terminal device monitors the PDCCH based on an SS set of one of the SSSGs. For example, the network device configures SSSGs on the switched-to BWP. There are two SSSGs: an SSSG0 and an SSSG1. The terminal device monitors the PDCCH based on an SS set of the SSSG0 or an SS set of the SSSG1.

Optionally, there are three SSSGs: an SSSG0, an SSSG1, and an SSSG2. The terminal device monitors the PDCCH based on an SS set of the SSSG0, an SS set of the SSSG1, or an SS set of the SSSG2.

In an implementation, the SSSG is configured on the switched-to BWP, and on the switched-to BWP, the terminal device monitors the PDCCH based on an SS set of an SSSG agreed in a protocol, where the SSSG agreed in the protocol is the SSSG0, the SSSG1, or the SSSG2. For example, the SSSG is configured on the switched-to BWP, and according to the protocol, the terminal device monitors the PDCCH on the switched-to BWP based on the SS set of the SSSG0. In another implementation, the network device configures one SSSG as an SSSG used by the terminal device to monitor the PDCCH on the switched-to BWP. For example, the SSSG configured by the network device is the SSSG0. In this case, the terminal device monitors the PDCCH on the switched-to BWP based on the SS set of the SSSG0.

Optionally, the network device sends third DCI to the terminal device on the currently active DL BWP, and the third DCI further carries scheduling information of a PUSCH. In a TDD scenario, the terminal device switches to a UL BWP in an indicator field in the third DCI based on the third DCI, and switches the DL BWP at the same time. In other words, the terminal device switches a UL BWP and the DL BWP at the same time. The terminal device stops, based on that monitoring of the PDCCH is stopped within the first duration that is indicated by the third DCI, monitoring the PDCCH in the switched-to DL BWP, and determines the start moment of the first duration in at least one of the following manners: a next slot after a UL BWP switch delay; a slot in which the PUSCH is transmitted on a switched-to UL BWP; a slot next to a slot in which the PUSCH is transmitted on a switched-to UL BWP; a time offset between the start moment of the first duration and the third DCI; a maximum value between a minimum slot offset and a duration for parsing the third DCI, where for description of the duration for parsing the third DCI, refer to the duration for parsing the second DCI; a moment after the PUSCH is transmitted in response to the PUSCH being scheduled by using the third DCI; or a moment after an uplink retransmission timer (UL retransmission timer) in C-DRX ends. Optionally, at least two of the manners is further compared to determine a later moment as the start moment of the first duration. For details, refer to the description in the foregoing paragraph. Details are not described herein again.

The BWP indicator field in the third DCI indicates an identifier of a UL BWP (UL BWP 2), and the identifier is different from an identifier of the currently active UL BWP (UL BWP 1). Based on the third DCI, the network device and the terminal device switch from the currently active UL BWP 1 to the UL BWP 2, and use the UL BWP 2 as a newly active UL BWP. The terminal device receives, on the UL BWP 2, the PUSCH scheduled by using the third DCI.

In the TDD scenario, the UL BWP and the DL BWP are associated, and a DL BWP and a UL BWP with a same identifier have a same center frequency. Therefore, in the TDD scenario, in response to the UL BWP being switched, the DL BWP is also correspondingly switched. To be specific, in response to the terminal device switching from the UL BWP 1 to the UL BWP 2, the terminal device also switches from the DL BWP 1 to the DL BWP 2.

In the TDD scenario, the terminal device determines the start moment of the first duration based on at least one of the next slot after the UL BWP switch delay, the slot in which the PUSCH is transmitted on the switched-to UL BWP, the slot next to the slot in which the PUSCH is transmitted on the switched-to UL BWP, the time offset between the start moment of the first duration and the third DCI, the maximum value between the minimum slot offset and the duration for parsing the third DCI, or the moment after the PUSCH is transmitted in response to the PUSCH being scheduled by using the third DCI.

Optionally, in response to the search space set group (SSSG) switching mechanism being configured for the terminal device, in response to the second DCI or the third DCI indicating to perform SSSG switching, that is, the second DCI or the third DCI indicating the terminal device to monitor the PDCCH based on one of search space set groups, and indicating to perform BWP switching. The method in the method 1000 is also applicable. The start moment of the first duration is a moment at which an SSSG indicated by the second DCI or the third DCI starts to take effect on the switched-to DL BWP. This is understood as follows: A start moment of the SSSG (or referred to as an effect taking moment of the SSSG), namely, a start moment at which the terminal device monitors the PDCCH on the switched-to DL BWP based on the SSSG indicated by the second DCI or the third DCI, is determined according to the method in the method 1000. A difference lies in that the start moment of the first duration is replaced with the effect taking moment of the SSSG. Details are not described again. Optionally, an implementation for the start moment at which the terminal device monitors the PDCCH on the switched-to DL BWP based on the SSSG indicated by the second DCI or the third DCI (which is referred to as the start moment of the SSSG for short) is different from the implementation of determining the start moment of the first duration.

The second DCI or the third DCI indicates to perform SSSG switching and indicate to perform BWP switching. In response to the start moment of the SSSG being later than the end moment of the BWP switch delay, or the start moment of the SSSG being after the slot in which the PDSCH scheduled by using the second DCI being located, behavior of monitoring the PDCCH by the terminal device after the BWP switch delay and before the start moment of the SSSG is: The terminal device monitors the PDCCH based on an SS set of one of the SSSGs.

For example, the network device configures SSSGs on the switched-to BWP. There are two SSSGs: an SSSG0 (that is, an index of the SSSG is 0) and an SSSG1 (that is, an index of the SSSG is 1). The terminal device monitors the PDCCH based on an SS set of the SSSG0 or an SS set of the SSSG1.

Optionally, there are three SSSGs: an SSSG0 (that is, an index of the SSSG is 0), an SSSG1 (that is, an index of the SSSG is 1), and an SSSG2 (that is, an index of the SSSG is 2). The terminal device monitors the PDCCH based on an SS set of the SSSG0, an SS set of the SSSG1, or an SS set of the SSSG2.

In an implementation, the SSSG is configured on the switched-to BWP, and on the switched-to BWP, the terminal device monitors the PDCCH based on an SS set of an SSSG agreed in a protocol, where the SSSG agreed in the protocol is the SSSG0, the SSSG1, or the SSSG2. For example, the SSSG is configured on the switched-to BWP, and according to the protocol, the terminal device monitors the PDCCH on the switched-to BWP based on the SS set of the SSSG0. In another implementation, the network device configures one SSSG as an SSSG used by the terminal device to monitor the PDCCH on the switched-to BWP. For example, the SSSG configured by the network device is the SSSG0. In this case, the terminal device monitors the PDCCH on the switched-to BWP based on the SS set of the SSSG0.

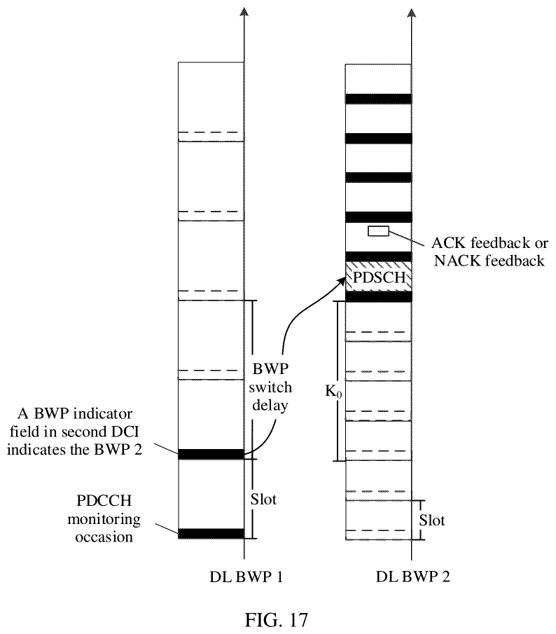

On the switched-to BWP, the terminal device starts to monitor the PDCCH from the slot in which the PDSCH scheduled by using the second DCI is located. Therefore, the behavior of monitoring the PDCCH by the terminal device after the BWP switch delay and before the effect taking moment of the SSSG includes the foregoing method. the behavior of monitoring the PDCCH by the terminal device before the effect taking moment of the SSSG and from the slot in which the PDSCH scheduled by using the second DCI is located includes the foregoing method. For example, FIG. 17 is a schematic diagram of stopping monitoring a PDCCH. As shown in FIG. 17, a block filled with a black pattern indicates a PDCCH monitoring occasion on which a terminal device is to perform monitoring. A network device configures a DL BWP 1 and a DL BWP 2 in a cell. A subcarrier spacing of the DL BWP 1 is 30 kHz, a BWP switch delay is two slots, a subcarrier spacing of the DL BWP 2 is 60 kHz, and a slot offset K₀ between a PDCCH carrying the second DCI and a PDSCH scheduled by using the second DCI is four slots. K₀ is equal to the BWP switch delay. Different subcarrier spacings correspond to different slot lengths. A length of a slot included in K₀ is a slot length corresponding to a subcarrier spacing of the switched-to BWP, that is, a slot length corresponding to a subcarrier spacing of 60 kHz. A length of a slot included in the BWP switch delay is a slot length corresponding to a subcarrier spacing of 30 kHz. Quantities of slots included in K₀ and the BWP switch delay are merely examples. This is not limited in at least one embodiment.

The DL BWP 1 is a currently active BWP, and the terminal device monitors a PDCCH on the active DL BWP 1. The terminal device detects that a BWP indicator field in the second DCI indicates the DL BWP 2, the second DCI indicates the terminal device to perform SSSG switching, and the second DCI is used to schedule transmission of the PDSCH. In addition, the terminal device is to perform ACK or NCK feedback to the network device. A start moment of an SSSG is after an ACK or NACK feedback duration.

As shown in FIG. 17, the terminal device transmits, based on the second DCI, the PDSCH on the DL BWP 2 after the BWP switch delay (two slots), and performs SSSG switching while performing ACK or NCK feedback. An SSSG mechanism is configured on the DL BWP 2. The ACK or the ACK in the figure only indicates that a time sequence is after the PDSCH, and does not indicate that the ACK or the NACK and the PDSCH are on a same BWP.

After the BWP switch delay and before the start moment of the SSSGs, the terminal device monitors the PDCCH based on an SS set of one of SSSGs.

Optionally, the method in the method 1000 that the terminal device determines the start moment of the first duration based on at least one of the time offset between the start moment of the first duration and the first DCI, the maximum value between the minimum slot offset and the duration for parsing the first DCI, the moment after the hybrid automatic repeat request HARQ corresponding to the PDSCH is fed back in response to the PDSCH being scheduled by using the first DCI, or the moment after the PUSCH being transmitted in response to the PUSCH being scheduled by using the first DCI is also applicable to the method 600 and the method 800. Details are not described herein again.

The terminal device supports a PDCCH monitoring skipping mechanism but does not support the SSSG switching mechanism, or the terminal device supports the SSSG switching mechanism but does not support a PDCCH monitoring skipping mechanism. In addition, the terminal device further supports both the PDCCH monitoring skipping mechanism and the SSSG switching mechanism.

In response to there being a plurality of DL BWPs, the network device configures a same mechanism or different mechanisms for the terminal device on different DL BWPs.

For example, in response to there being three DL BWPs, the three DL BWPs are a DL BWP 1, a DL BWP 2, and a DL BWP 3. The DL BWP 1, the DL BWP 2, and the DL BWP 3 all supports the PDCCH monitoring skipping mechanism, but do not support the SSSG switching mechanism. Alternatively, the DL BWP 1 supports the PDCCH monitoring skipping mechanism but does not support the SSSG switching mechanism, the DL BWP 2 supports the SSSG switching mechanism but does not support the PDCCH monitoring skipping mechanism, and the DL BWP 3 supports the PDCCH monitoring skipping mechanism and supports the SSSG switching mechanism.

Optionally, the DL BWP does not support the PDCCH monitoring skipping mechanism, and does not support the SSSG mechanism.

The terminal device reports, to the network device in an explicit or implicit manner, the mechanism supported by the terminal device (the PDCCH monitoring skipping mechanism and/or the SSSG switching mechanism), the network device performs configuration for the terminal device based on the mechanism reported by the terminal device. For example, the network device configures, by using RRC signaling, the PDCCH monitoring skipping mechanism and/or the SSSG switching mechanism for the terminal device. In at least one embodiment, a specific reporting manner of the terminal device is not limited, and a specific configuration manner of the network device is not limited.

For example, a supported mechanism reported by the terminal device to the network device is the PDCCH monitoring skipping mechanism, and the network device configures the PDCCH monitoring skipping mechanism for the terminal device.

In response to the network device and the terminal device determining the supported mechanism, the network device further indicates behavior of the terminal device by using the DCI.

In at least one embodiment, a mechanism determined by the network device and the terminal device on the active DL BWP is the PDCCH monitoring skipping mechanism, and the network device indicates the behavior of the terminal device by using a bit value in the DCI. the network device configures the PDCCH monitoring skipping mechanism for the terminal device on the active DL BWP.

For example, in response to a quantity of first durations T in the PDCCH monitoring skipping mechanism being one, the network device indicates the behavior of the terminal device based on a mapping relationship shown in Table 4. In response to a quantity of first durations Tin the PDCCH monitoring skipping mechanism being greater than one (for example, three), the network device indicates the behavior of the terminal device based on a mapping relationship shown in Table 5. Different first durations T is represented by subscript numbers, for example, T₁, T₂, and T₃. The network device configures one or more first durations for the terminal device by using RRC signaling. The table is merely an example. Alternatively, a mapping relationship between a bit in the DCI and behavior of the terminal device is in another form. This is not limited in embodiments described herein.

TABLE 4

| One bit in | |
|---|---|
| the DCI | Behavior of the terminal device |
| 0 | Monitor a PDCCH, that is, monitor a PDCCH based on a |
| | configured SS set |
| 1 | Stop monitoring a PDCCH within the first duration |

TABLE 5

| Two bits | |
|---|---|
| in the DCI | Behavior of the terminal device |
| 00 | Monitor a PDCCH, that is, monitor a PDCCH based on a |
| | configured SS set |
| 01 | Stop monitoring a PDCCH within a first duration T₁ |
| 10 | Stop monitoring a PDCCH within a first duration T₂ |
| 11 | Stop monitoring a PDCCH within a first duration T₃, or in |
| | response to the first duration T₃ not being configured, |
| | reservation is made |

As shown in Table 4, the quantity of first durations T in the PDCCH monitoring skipping mechanism is 1, and the network device indicates the behavior of the terminal device by using the bit in the DCI. In response to a value of the bit being 0, the DCI indicates the terminal device to monitor the PDCCH (that is, monitor the PDCCH based on the configured SS set). The terminal device is understood to not skip PDCCH monitoring. In response to a value of the bit being 1, the DCI indicates the terminal device to stop monitoring the PDCCH within the first duration.

As shown in Table 5, the quantity of first durations T in the PDCCH monitoring skipping mechanism is equal to 3, and the three first durations are T₁, T₂, and T₃. The network device indicates the behavior of the terminal device by using the two bits in the DCI. In response to a value of the two bits being 00, the DCI indicates the terminal device to monitor the PDCCH (that is, monitor the PDCCH based on the configured SS set). In response to a value of the two bits being 01, the DCI indicates the terminal device to stop monitoring the PDCCH within the first duration T₁. In response to a value of the two bits being 10, the DCI indicates the terminal device to stop monitoring the PDCCH within the first duration T₂. In response to a value of the two bits being 11, the DCI indicates the terminal device to stop monitoring the PDCCH within the first duration T₃. Optionally, in response to the network device not configuring the first duration T₃, that a value of the two bits is 11 is reserved, that is, meaningless.

In at least one embodiment, a mechanism determined by the network device and the terminal device on the active DL BWP is the SSSG switching mechanism, and the network device indicates the behavior of the terminal device by using a bit value in the DCI. the network device configures the SSSG switching mechanism for the terminal device on the active DL BWP.

For example, in response to the network device configuring two SSSGs, the network device indicates the behavior of the terminal device based on a mapping relationship shown in Table 6. In response to the network device configuring three SSSGs, the network device indicates the behavior of the terminal device based on a mapping relationship shown in Table 7.

TABLE 6

| One bit | |
|---|---|
| in the DCI | Behavior of the terminal device |
| 0 | Monitor a PDCCH based on an SS set of an SSSG0, and |
| | do not monitor the PDCCH based on an SS set of an SSSG1 |
| 1 | Monitor a PDCCH based on an SS set of an SSSG1, and |
| | do not monitor the PDCCH based on an SS set of an SSSG0 |

TABLE 7

| Two | |
|---|---|
| bits in | |
| the DCI | Behavior of the terminal device |
| 00 | Monitor a PDCCH based on an SS set of an SSSG0, and do not |
| | monitor the PDCCH based on an SS set of an SSSG1 and an SS |
| | set of an SSSG2 |
| 01 | Monitor a PDCCH based on an SS set of an SSSG1, and do not |
| | monitor the PDCCH based on an SS set of an SSSG0 and an SS |
| | set of an SSSG2 |
| 10 | Monitor a PDCCH based on an SS set of an SSSG2, and do not |
| | monitor the PDCCH based on an SS set of an SSSG0 and an SS |
| | set of an SSSG1 |
| 11 | Reserved |

As shown in Table 6, in response to the network device configuring two SSSGs: the SSSG0 and the SSSG1, the network device indicates the behavior of the terminal device by using the bit in the DCI. In response to a value of the bit being 0, the DCI indicates the terminal device to monitor the PDCCH based on the SS set of the SSSG0, and not to monitor the PDCCH based on the SS set of the SSSG1. In response to a value of the bit being 1, the DCI indicates the terminal device to monitor the PDCCH based on the SS set of the SSSG1, and not to monitor the PDCCH based on the SS set of the SSSG0.

As shown in Table 7, in response to the network device configuring three SSSGs: the SSG0, the SSSG1, and the SSSG2, the network device indicates the behavior of the terminal device by using the two bits in the DCI. In response to a value of the two bits being 00, the DCI indicates the terminal device to monitor the PDCCH based on the SS set of the SSSG0, and not to monitor the PDCCH based on the SS sets of the SSSG1 and the SSSG2. In response to a value of the two bits being 01, the DCI indicates the terminal device to monitor the PDCCH based on the SS set of the SSSG1, and not to monitor the PDCCH based on the SS sets of the SSSG0 and the SSSG2. In response to a value of the two bits being 10, the DCI indicates the terminal device to monitor the PDCCH based on the SS set of the SSSG2, and not to monitor the PDCCH based on the SS sets of the SSSG0 and the SSSG1. That a value of the two bits is 11 is reserved.

In at least one embodiment, mechanisms determined by the network device and the terminal device on the active DL BWP are the PDCCH monitoring skipping mechanism and the SSSG switching mechanism, and the network device indicates the behavior of the terminal device by using a bit value in the DCI. The network device configures the PDCCH monitoring skipping mechanism and the SSSG switching mechanism for the terminal device on the active DL BWP.

For example, the mechanisms determined by the network device and the terminal device are the PDCCH monitoring skipping mechanism and the SSSG switching mechanism. In response to the network device configuring two SSSGs: an SSSG0 and an SSSG1, and a quantity of first durations T is one, the network device indicates the behavior of the terminal device based on a mapping relationship shown in Table 8 or Table 9. In response to the network device configuring two SSSGs: an SSSG0 and an SSSG1, and a quantity of first durations T is two, the network device indicates the behavior of the terminal device based on a mapping relationship shown in Table 10 or Table 11.

TABLE 8

| Two bits | |
|---|---|
| in the DCI | Behavior of the terminal device |
| 00 | Monitor a PDCCH based on an SS set of an SSSG0, and |
| | do not monitor the PDCCH based on an SS set of an SSSG1 |
| 01 | Monitor a PDCCH based on an SS set of an SSSG1, and |
| | do not monitor the PDCCH based on an SS set of an SSSG0 |
| 10 | Stop monitoring a PDCCH within a first duration T |
| 11 | Reserved |

TABLE 9

| Two bits | |
|---|---|
| in the DCI | Behavior of the terminal device |
| 00 | Monitor a PDCCH based on an SS set of an SSSG0, and |
| | do not monitor the PDCCH based on an SS set of an SSSG1 |
| 01 | Monitor a PDCCH based on an SS set of an SSSG1, and |
| | do not monitor the PDCCH based on an SS set of an SSSG0 |
| 10 | Switch to or remain in an SSSG0, and |
| | stop monitoring a PDCCH within a first duration T |
| 11 | Switch to or remain in an SSSG1, and |
| | stop monitoring a PDCCH within a first duration T |

TABLE 10

| Two bits | |
|---|---|
| in the DCI | Behavior of the terminal device |
| 00 | Monitor a PDCCH based on an SS set of an SSSG0, and |
| | do not monitor the PDCCH based on an SS set of an SSSG1 |
| 01 | Monitor a PDCCH based on an SS set of an SSSG1, and |
| | do not monitor the PDCCH based on an SS set of an SSSG0 |
| 10 | Switch to or remain in an SSSG0, and |
| | stop monitoring a PDCCH within a first duration T₁ |
| 11 | Switch to or remain in an SSSG0, and |
| | stop monitoring a PDCCH within a first duration T₂ |

TABLE 11

| Two bits | |
|---|---|
| in the DCI | Behavior of the terminal device |
| 00 | Monitor a PDCCH based on an SS set of an SSSG0, and |
| | do not monitor the PDCCH based on an SS set of an SSSG1 |
| 01 | Monitor a PDCCH based on an SS set of an SSSG1, and |
| | do not monitor the PDCCH based on an SS set of an SSSG0 |
| 10 | Stop monitoring a PDCCH within a first duration T₁ |
| 11 | Stop monitoring a PDCCH within a first duration T₂ |

As shown in Table 8, the network device indicates the behavior of the terminal device by using the two bits in the DCI. In response to a value of the two bits being 00, the DCI indicates the terminal device to monitor the PDCCH based on the SS set of the SSSG0, and not to monitor the PDCCH based on the SS set of the SSSG1. In response to a value of the two bits being 01, the DCI indicates the terminal device to monitor the PDCCH based on the SS set of the SSSG1, and not to monitor the PDCCH based on the SS set of the SSSG0. In response to a value of the two bits being 10, the DCI indicates the terminal device to stop monitoring the PDCCH within the first duration T, and the terminal device remains in a current SSSG without switching the SSSG. That a value of the two bits is 11 is reserved.

As shown in Table 9, the network device indicates the behavior of the terminal device by using the two bits in the DCI. In response to a value of the two bits being 00, the DCI indicates the terminal device to monitor the PDCCH based on the SS set of the SSSG0, and to monitor the PDCCH based on the SS set of the SSSG1. In response to a value of the two bits being 01, the DCI indicates the terminal device to monitor the PDCCH based on the SS set of the SSSG1, and not to monitor the PDCCH based on the SS set of the SSSG0. In response to a value of the two bits being 10, the DCI indicates the terminal device to switch to or remain in the SSSG0 and stop monitoring the PDCCH within the first duration T. In response to a value of the two bits being 11, the DCI indicates the terminal device to switch to or remain in the SSSGI and stop monitoring the PDCCH within the first duration T.

As shown in Table 10, the network device indicates the behavior of the terminal device by using the two bits in the DCI. In response to a value of the two bits being 00, the DCI indicates the terminal device to monitor the PDCCH based on the SS set of the SSSG0, and not to monitor the PDCCH based on the SS set of the SSSG1. In response to a value of the two bits being 01, the DCI indicates the terminal device to monitor the PDCCH based on the SS set of the SSSG1, and not to monitor the PDCCH based on the SS set of the SSSG0. In response to a value of the two bits being 10, the DCI indicates the terminal device to switch to or remain in the SSSG0 and stop monitoring the PDCCH within the first duration T₁. In response to a value of the two bits being 11, the DCI indicates the terminal device to switch to or remain in the SSSG0 and stop monitoring the PDCCH within the first duration T₂.

As shown in Table 11, the network device indicates the behavior of the terminal device by using the two bits in the DCI. In response to a value of the two bits being 00, the DCI indicates the terminal device to monitor the PDCCH based on the SS set of the SSSG0, and not to monitor the PDCCH based on the SS set of the SSSG1. In response to a value of the two bits being 01, the DCI indicates the terminal device to monitor the PDCCH based on the SS set of the SSSG1, and not to monitor the PDCCH based on the SS set of the SSSG0. In response to a value of the two bits being 10, the DCI indicates the terminal device to stop monitoring the PDCCH within the first duration T₁, and the terminal device remains in a current SSSG without switching the SSSG. In response to a value of the two bits being 11, the DCI indicates the terminal device to stop monitoring the PDCCH within the first duration T₂, and the terminal device remains in a current SSSG without switching the SSSG.

For example, the mechanisms determined by the network device and the terminal device are the PDCCH monitoring skipping mechanism and the SSSG switching mechanism. In response to the network device configuring three SSSGs: an SSSG0, an SSSG1, and an SSSG2, and a first duration is T, the network device indicates the behavior of the terminal device based on any one of the mapping relationships shown in Table 12.

TABLE 12

| Two | |
|---|---|
| bits in | |
| the DCI | Behavior of the terminal device |
| 00 | Monitor a PDCCH based on an SS set of an SSSG0, and do not |
| | monitor the PDCCH based on an SS set of an SSSG1 and an SS |
| | set of an SSSG2 |
| 01 | Monitor a PDCCH based on an SS set of an SSSG1, and do not |
| | monitor the PDCCH based on an SS set of an SSSG0 and an SS |
| | set of an SSSG2 |
| 10 | Monitor a PDCCH based on an SS set of an SSSG2, and do not |
| | monitor the PDCCH based on an SS set of an SSSG0 and an SS |
| | set of an SSSG1 |
| 11 | Stop monitoring a PDCCH within a first duration T |

As shown in Table 12, the network device indicates the behavior of the terminal device by using the two bits in the DCI. In response to a value of the two bits being 00, the DCI indicates the terminal device to monitor the PDCCH based on the SS set of the SSSG0, and not to monitor the PDCCH based on the SS sets of the SSSG1 and the SSSG2. In response to a value of the two bits being 01, the DCI indicates the terminal device to monitor the PDCCH based on the SS set of the SSSG1, and not to monitor the PDCCH based on the SS sets of the SSSG0 and the SSSG2. In response to a value of the two bits being 10, the DCI indicates the terminal device to monitor the PDCCH based on the SS set of the SSSG2, and not to monitor the PDCCH based on the SS sets of the SSSG0 and the SSSG1. In response to a value of the two bits being 11, the DCI indicates the terminal device to stop monitoring the PDCCH within the first duration T, and the terminal device remains in a current SSSG without switching the SSSG.

In at least one embodiment, one bit or two bits in the mapping relationships shown in Table 4 to Table 12 are referred to as a “first field”. A name is not limited in at least one embodiment.

In the method 600, the method 800, and the method 1000, behavior of the terminal device on the switched-to BWP is determined based on a value of the first field in the DCI and a mapping relationship for the first field in the switched-to BWP.

For example, in the method 600, the method 800, and the method 1000, the terminal device supports the PDCCH monitoring skipping mechanism, and the terminal device performs the following operations based on a value of a first field in the second DCI or the third DCI: the behavior of the terminal device corresponding to the value of the first field separately determined in Table 4 to Table 12, so as to determine the behavior on the switched-to BWP. In other words, monitoring of the PDCCH is stopped at the start moment of the first duration, or the PDCCH is monitored at the start moment of the SSSG based on the SSSG indicated by the second DCI or the third DCI.

Optionally, in response to the terminal device monitoring the PDCCH on the switched-to BWP, the network device sends DCI on the switched-to BWP to indicate the behavior of the terminal device, that is, indicate the terminal device to switch the SSSG and/or skip PDCCH monitoring. The terminal device performs corresponding behavior based on the received DCI.

Optionally, based on the first field, the behavior of monitoring the PDCCH by the terminal device after the BWP switch delay and before the start moment of the first duration or the start moment of the SSSG is by default the behavior of the terminal device corresponding to “0” or “00” in the mapping relationship for the first field in the DCI. The mapping relationship for the first field is understood as being agreed in the foregoing protocol.

Optionally, the network device configures the timer for the terminal device, and the timer is used for BWP switching. In response to the timer expiring, the terminal device performs DL BWP switching. Correspondingly, the network device also performs DL BWP switching. On a switched-to DL BWP, the default behavior of monitoring the PDCCH by the terminal device is the behavior of the terminal device corresponding to “0” or “00” in the mapping relationship for the first field in the DCI.

Optionally, in the method 1000, in response to the second DCI or the third DCI not having the first field, but indicating to perform BWP switching, the terminal device performs DL BWP switching based on the second DCI or the third DCI. On a switched-to DL BWP, the default behavior of monitoring the PDCCH by the terminal device is the behavior of the terminal device corresponding to “0” or “00” in the mapping relationship for the first field in the DCI.

The terminal device supports both the PDCCH monitoring skipping mechanism and the SSSG switching mechanism. The network device indicates, by using one piece of DCI, the terminal device to stop monitoring the PDCCH within the first duration and indicate the terminal device to perform SSSG switching.

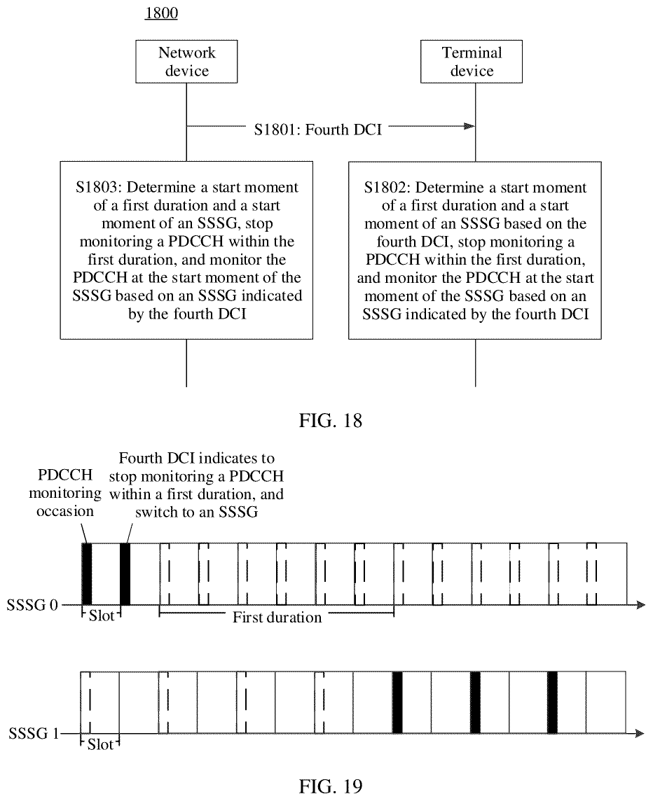

For example, FIG. 18 is a schematic flowchart of another method 1800 for stopping monitoring a PDCCH according to at least one embodiment. The method 1800 is applied to the communication system 500 shown in FIG. 5. However, at least one embodiment is not limited thereto. As shown in FIG. 18, the method 1800 includes the following steps.

S1801: A network device sends fourth DCI to a terminal device on an active DL BWP, where the fourth DCI indicates the terminal device to stop monitoring a PDCCH within a first duration, and indicates to perform SSSG switching, and the PDCCH on which monitoring is stopped includes a PDCCH in a type 3 common search space set and a PDCCH in a terminal device-specific search space set. Correspondingly, the terminal device receives the fourth DCI on the active DL BWP.

The fourth DCI indicates to perform SSSG switching, to be specific, the fourth DCI indicates the terminal device to switch to a first search space set group. For example, the fourth DCI indicates the terminal device to switch to an SSSG0, an SSSG1, or an SSSG2.

The terminal device currently monitors the PDCCH based on an SS set of the SSSG0, the terminal device currently monitors the PDCCH based on an SS set of the SSSG1, or the terminal device currently monitors the PDCCH based on an SS set of the SSSG2. This is not limited in at least one embodiment. In response to an SSSG currently used by the terminal device being the same as an SSSG indicated by the fourth DCI, the SSSG used by the terminal device is not switched.

S1802: The terminal device determines a start moment of the first duration and a start moment of the SSSG based on the fourth DCI, stops monitoring the PDCCH within the first duration, and monitors the PDCCH at the start moment of the SSSG based on the SSSG indicated by the fourth DCI.

S1803: The network device determines a start moment of the first duration and a start moment of the SSSG.

A sequence of S1802 and S1803 is not distinguished.

The network device does not send the PDCCH within the first duration, and sends the PDCCH in the SSSG indicated by the fourth DCI after the start moment of the SSSG.

A method for determining the start moment of the first duration and the start moment of the SSSG by the network device is the same as the method for determining the start moment of the first duration and the start moment of the SSSG by the terminal device.

Optionally, in a scenario with a plurality of DL BWPs, the fourth DCI simultaneously indicates to stop monitoring the PDCCH within the first duration, performs SSSG switching, and performs BWP switching.

In response to a function of indicating SSSG switching being added to the second DCI in the method 1000, the second DCI is the same as the four DCI.

Embodiments described herein provide the method for determining the start moment of the first duration and the start moment of the SSSG by the terminal device.

In at least one embodiment, the terminal device first determines the start moment of the first duration. The terminal device determines the start moment of the first duration based on the implementation of determining the start moment of the first duration in the method 1000. Then, after the first duration, the terminal device monitors the PDCCH based on an SS set of an SSSG indicated by DCI (for example, the fourth DCI). Before the first duration ends, the terminal device remains in the current SSSG, and after the first duration, the terminal device monitors the PDCCH based on the SS set of the SSSG indicated by the fourth DCI. Correspondingly, the network device determines the start moment of the first duration in the same implementation, and after the first duration, the network device sends the PDCCH to the terminal device based on the SS set of the SSSG indicated by the fourth DCI. In this manner, the start moment of the SSSG is a moment after the first duration. The start moment of the SSSG is a next slot or symbol after the first duration.

Specifically, the implementation of determining the start moment of the first duration includes:
(1) a time offset between the start moment of the first duration and the fourth DCI;
(2) a start moment of the first duration is a maximum value between a minimum slot offset and a duration for parsing the fourth DCI, where the minimum slot offset is a minimum slot offset between a PDCCH carrying the fourth DCI and a PDSCH that is allowed to be scheduled by using the fourth DCI;
(3) a moment after a HARQ corresponding to a PDSCH is fed back in response to the PDSCH being scheduled by using the fourth DCI; and
(4) a moment after a PUSCH is transmitted in response to the PUSCH being scheduled by using the fourth DCI, or a moment after an uplink retransmission timer (UL retransmission timer) in C-DRX ends.

For specific descriptions of the four implementations, refer to the descriptions of the fourth implementation to the sixth implementation. Details are not described herein again.

The terminal device and the network device determine the start moment of the first duration in at least one of the four manners.

For example, FIG. 19 is a schematic diagram of stopping monitoring a PDCCH. As shown in FIG. 19, a block filled with a black pattern indicates a PDCCH monitoring occasion on which a terminal device is to perform monitoring. A network device configures an SSSG 0 and an SSSG 1 on an active DL BWP. A PDCCH monitoring occasion of an SS set of the SSSG 0 uses one slot as a periodicity. A PDCCH monitoring occasion of an SS set of the SSSG 1 uses two slots as a periodicity. PDCCH monitoring occasions of the SSSG 1 are sparse compared with PDCCH monitoring occasions of the SSSG 0. A first duration is six slots.

The terminal device monitors a PDCCH on the active DL BWP, and monitors the PDCCH based on the SS set of the SSSG0. The network device indicates, by using a PDCCH carrying the fourth DCI, the terminal device to stop monitoring the PDCCH within the first duration and indicates the terminal device to switch to the SSSG1. The terminal device obtains, through monitoring, the PDCCH carrying the fourth DCI. As shown in FIG. 19, the terminal device determines, based on the fourth DCI, that a time offset between a start moment of the first duration and the fourth DCI is one slot, and does not monitor the PDCCH within the first duration (six slots). After the first duration, the terminal device monitors the PDCCH based on the SS set of the SSSG1. Within the first duration (six slots), the terminal device still remains in the SSSG0.

Optionally, in a scenario with a plurality of DL BWPs, the fourth DCI simultaneously indicates to stop monitoring the PDCCH within the first duration, performs SSSG switching, and performs BWP switching. The terminal device first determines the start moment of the first duration. On a switched-to BWP, the terminal device stops monitoring the PDCCH within the first duration, and after the first duration, the terminal device monitors the PDCCH based on the SS set of the SSSG indicated by the fourth DCI. On the switched-to BWP, before the first duration ends, the terminal device is in one of SSSGs, for example, the SSSG0 or an SSSG that has a same index as an SSSG used by the terminal device on a switched-from BWP.

In at least one embodiment, the start moment of the first duration is the same as the start moment of the SSSG. A specific method includes: a manner 1: determining the start moment of the first duration, and using the start moment of the first duration as the start moment of the SSSG; a manner 2: determining the start moment of the SSSG, and using the start moment of the SSSG as the start moment of the first duration; or a manner 3: separately determining the start moment of the first duration and the start moment of the SSSG, and using a later moment of the two as the start moment of the first duration and the start moment of the SSSG.

The implementation of determining the start moment of the SSSG includes:
(1) a time offset between the start moment of the SSSG and the fourth DCI;
(2) a start moment of the SSSG is a maximum value between a minimum slot offset and a duration for parsing the fourth DCI, where the minimum slot offset is a minimum slot offset between a PDCCH carrying the fourth DCI and a PDSCH that is allowed to be scheduled by using the fourth DCI;
(3) a moment after a HARQ corresponding to a PDSCH is fed back in response to the PDSCH being scheduled by using the fourth DCI; and
(4) a moment after a PUSCH is transmitted in response to the PUSCH being scheduled by using the fourth DCI, or a moment after an uplink retransmission timer (UL retransmission timer) in C-DRX ends.

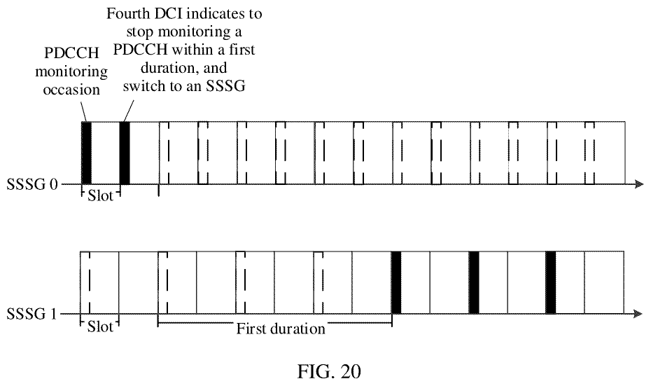

For example, FIG. 20 is a schematic diagram of stopping monitoring a PDCCH. As shown in FIG. 20, a block filled with a black pattern indicates a PDCCH monitoring occasion on which a terminal device is to perform monitoring. A network device configures an SSSG 0 and an SSSG 1 on an active DL BWP. A PDCCH monitoring occasion of an SS set of the SSSG 0 uses one slot as a periodicity. A PDCCH monitoring occasion of an SS set of the SSSG 1 uses two slots as a periodicity. PDCCH monitoring occasions of the SSSG 1 are sparse compared with PDCCH monitoring occasions of the SSSG 0. A first duration is six slots.

The terminal device monitors a PDCCH on the active DL BWP, and monitors the PDCCH based on the SS set of the SSSG0. The network device indicates, by using a PDCCH carrying the fourth DCI, the terminal device to stop monitoring the PDCCH within the first duration and indicates the terminal device to switch to the SSSG1. The terminal device obtains, through monitoring, the PDCCH carrying the fourth DCI. As shown in FIG. 20, the manner 1 is used as an example. The terminal device determines, based on fourth DCI, that a time offset between the start moment of the first duration and the fourth DCI is one slot, and uses the start moment of the first duration as the start moment of the SSSG. In this case, a time offset between both the start moment of the first duration and the start moment of the SSSG and the fourth DCI is one slot, and the terminal device switches to the SSSG1 at the start moment of the first duration, stops monitoring the PDCCH within the first duration (six slots), and monitors the PDCCH based on the SS set of the SSSG1 after the first duration (six slots). Within the first duration (six slots), an SSSG in which the terminal device is located is the SSSG1.

Optionally, a same specific implementation for the start moment of the first duration and the start moment of the SSSG further includes the manner 3: The foregoing implementation of determining the start moment of the first duration is used for the start moment of the first duration. The foregoing implementation of determining the start moment of the first duration is also used for the start moment of the SSSG. In response to the determined start moment of the first duration being different from the determined start moment of the SSSG, a later moment of the two is determined as the start moment of the first duration and the start moment of the SSSG.

Optionally, in a scenario with a plurality of DL BWPs, the fourth DCI simultaneously indicates to stop monitoring the PDCCH within the first duration, performs SSSG switching, and performs BWP switching. The terminal device determines that the start moment of the first duration is the same as the start moment of the SSSG. A specific method also includes: a manner 1: determining the start moment of the first duration, and using the start moment of the first duration as the start moment of the SSSG; a manner 2: determining the start moment of the SSSG, and using the start moment of the SSSG as the start moment of the first duration; or a manner 3: separately determining the start moment of the first duration and the start moment of the SSSG, and using a later moment of the two as the start moment of the first duration and the start moment of the SSSG. For determining the start moment of the first duration and the start moment of determining the SSSG, refer to the description in the method 1000. Details are not described herein again.

For example, the implementation of determining the start moment of the first duration or the start moment of the SSSG further includes at least one of the following manners:
(1) a next slot after a BWP switch delay;
(2) a slot in which the PDSCH is transmitted on a switched-to DL BWP; and
(3) a slot next to a slot in which the PDSCH is transmitted on a switched-to DL BWP.

The terminal device determines the start moment of the first duration and the start moment of the SSSG in at least one of the foregoing three manners.

In at least one embodiment, the start moment of the first duration and the start moment of the SSSG are separately determined. The implementation of determining the start moment of the first duration in the method 1800 is used for the start moment of the first duration. The implementation of determining the start moment of the first duration in the method 1800 is also used for the start moment of the SSSG. The determined start moment of the first duration is different from the determined start moment of the SSSG. For example, the start moment of the first duration is determined based on a time offset between the start moment of the first duration and the fourth DCI, and the start moment of the SSSG is determined based on a moment at which a HARQ corresponding to a PDSCH scheduled by using the fourth DCI is fed back. The obtained start moment of the first duration is different from the determined start moment of the SSSG.

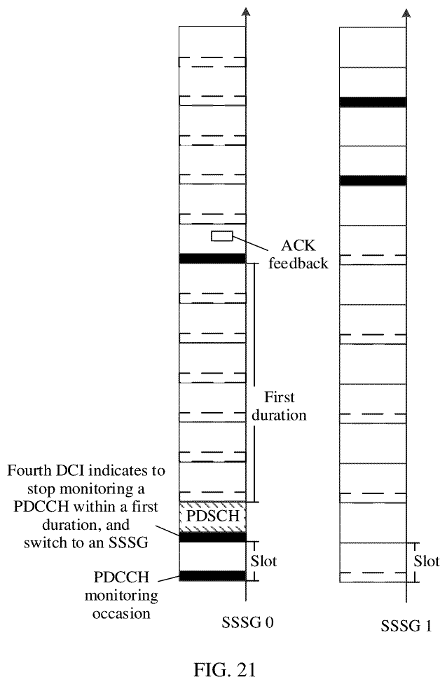

For example, FIG. 21 is a schematic diagram of stopping monitoring a PDCCH. As shown in FIG. 21, a block filled with a black pattern indicates a PDCCH monitoring occasion on which a terminal device is to perform monitoring. A network device configures an SSSG 0 and an SSSG 1 on an active DL BWP. A PDCCH monitoring occasion of an SS set of the SSSG 0 uses one slot as a periodicity. A PDCCH monitoring occasion of an SS set of the SSSG 1 uses two slots as a periodicity. PDCCH monitoring occasions of the SSSG 1 are sparse compared with PDCCH monitoring occasions of the SSSG 0. A first duration is six slots.

The terminal device monitors a PDCCH on the active DL BWP, and monitors the PDCCH based on the SS set of the SSSG0. The network device indicates, by using a PDCCH carrying the fourth DCI, the terminal device to stop monitoring the PDCCH within the first duration, switch to the SSSG1, and schedule the PDSCH. The terminal device obtains, through monitoring, the PDCCH carrying the fourth DCI. As shown in FIG. 21, the terminal device determines, based on the fourth DCI, that the time offset between the start moment of the first duration and the fourth DCI is one slot, and the PDSCH is transmitted in a slot in which the start moment of the first duration is located. The terminal device further determines that the start moment of the SSSG is after an ACK is transmitted, that is, stops monitoring the PDCCH within the first duration (6 slots), and a valid SSSG within the first duration is the SSSG0, that is, the terminal device is still in the SSSG0. After the terminal device transmits the ACK, the terminal device monitors the PDCCH based on the SS set of the SSSG1. The valid SSSG of the terminal device does not change before the start moment of the SSSG.

Optionally, in a scenario with a plurality of DL BWPs, the start moment of the first duration and the start moment of the SSSG are also separately determined. The implementation of determining the start moment of the first duration in the method 1000 is used for the start moment of the first duration. The implementation of determining the start moment of the first duration in the method 1000 is also used for the start moment of the SSSG. The determined start moment of the first duration is different from the determined start moment of the SSSG. The valid SSSG of the terminal device does not change before the start moment of the SSSG.

In at least one embodiment, the terminal device first determines the start moment of the first duration. For an implementation of determining the start moment of the first duration, refer to the description in the method 1000. Details are not described herein again. Then, the terminal device determines the start moment of the SSSG after the first duration, skips SSSG switching before the start moment of the SSSG, and monitors, after the start moment of the SSSG, the PDCCH based on an SS set of the SSSG indicated by the DCI. The terminal device and the network device determine the start moment of the SSSG by using an end moment of the first time as a reference point.

The start moment of the SSSG is determined based on a time offset between the start moment of the SSSG and the end moment of the first duration. The time offset between the start moment of the SSSG and the end moment of the first duration is predefined or configured by the network device. For a value of the time offset, refer to the value of the time offset between the start moment of the first duration and the DCI in the method 1000. Details are not described herein again.

For example, FIG. 22 is a schematic diagram of stopping monitoring a PDCCH. As shown in FIG. 22, a block filled with a black pattern indicates a PDCCH monitoring occasion on which a terminal device is to perform monitoring. A network device configures an SSSG0 and an SSSG1 on an active DL BWP. A PDCCH monitoring occasion of an SS set of the SSSG0 uses one slot as a periodicity. A PDCCH monitoring occasion of an SS set of SSSG1 uses two slots as a periodicity. PDCCH monitoring occasions of the SSSG1 are sparse compared with PDCCH monitoring occasions of the SSSG0. A first duration is six slots.

The terminal device monitors a PDCCH on the active DL BWP, and monitors the PDCCH based on the SS set of the SSSG0. The network device indicates, by using a PDCCH carrying the fourth DCI, the terminal device to stop monitoring the PDCCH within the first duration and indicates the terminal device to switch to the SSSG1. The terminal device obtains, through monitoring, the PDCCH carrying the fourth DCI. As shown in FIG. 22, the terminal device determines, based on the fourth DCI, that a time offset between the start moment of the first duration and the fourth DCI is one slot, and stops monitoring the PDCCH within the first duration (six slots). The terminal device determines that the time offset between the start moment of the SSSG and the end moment of the first duration is two slots, that is, after two slots of the end moment of the first duration, the terminal device switches to the SS set of the SSSG1 to monitor the PDCCH. After the end moment of the first duration and before the start moment of the SSSG, the terminal device monitors the PDCCH based on the SS set of the SSSG0.

Optionally, in a scenario with a plurality of DL BWPs, the fourth DCI simultaneously indicates to stop monitoring the PDCCH within the first duration, switches to the SSSG1, and performs BWP switching. For determining the start moment of the first duration by the terminal device, refer to the description in the method 1000. Details are not described herein again.

In at least one embodiment, the terminal device first determines the start moment of the SSSG. For an implementation of determining the start moment of the SSSG, refer to the description in the method 1000. Details are not described herein again. Then, the terminal device determines the start moment of the first duration. Before the start moment of the first duration, the terminal device monitors the PDCCH based on the SS set of the SSSG indicated by the DCI. After the start moment of the first duration, the terminal device stops monitoring the PDCCH within the first duration. The terminal device and the network device determine the start moment of the first duration by using the start moment of the SSSG as a reference point.

The start moment of the first duration is determined based on a time offset between the start moment of the SSSG and the start moment of the first duration. The time offset between the start moment of the SSSG and the start moment of the first duration is predefined or configured by the network device. For a value of the time offset, refer to the value of the time offset between the start moment of the first duration and the DCI in the method 1000. Details are not described herein again.

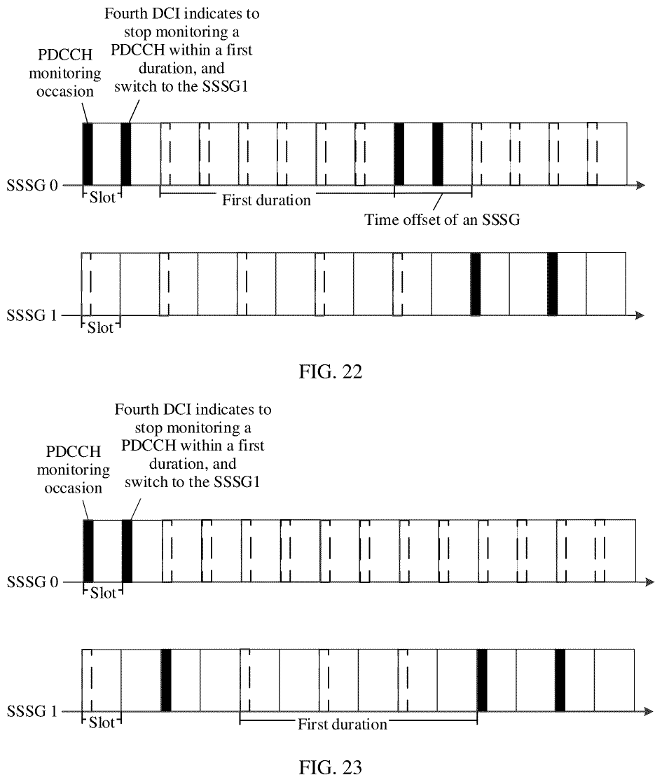

For example, FIG. 23 is a schematic diagram of stopping monitoring a PDCCH. As shown in FIG. 23, a block filled with a black pattern indicates a PDCCH monitoring occasion on which a terminal device is to perform monitoring. A network device configures an SSSG0 and an SSSG1 on an active DL BWP. A PDCCH monitoring occasion of an SS set of the SSSG0 uses one slot as a periodicity. A PDCCH monitoring occasion of an SS set of SSSG1 uses two slots as a periodicity. PDCCH monitoring occasions of the SSSG1 are sparse compared with PDCCH monitoring occasions of the SSSG0. A first duration is six slots.

The terminal device monitors a PDCCH on the active DL BWP, and monitors the PDCCH based on the SS set of the SSSG0. The network device indicates, by using a PDCCH carrying the fourth DCI, the terminal device to stop monitoring the PDCCH within the first duration and indicates the terminal device to switch to the SSSG1. The terminal device obtains, through monitoring, the PDCCH carrying the fourth DCI. As shown in FIG. 22, the terminal device determines, based on the fourth DCI, that a time offset between the start moment of the SSSG and the fourth DCI is one slot. The terminal device switches to the SS set of the SSSG1 to monitor the PDCCH. The terminal device determines that the time offset between the start moment of the first duration and the start moment of the SSSG is two slots, that is, after two slots of the start moment of the SSSG, the terminal device stops monitoring the PDCCH within the first duration. After the first duration, the PDCCH is still monitored based on the SS set of the SSSG1.

Optionally, in a scenario with a plurality of DL BWPs, the fourth DCI simultaneously indicates to stop monitoring the PDCCH within the first duration, switches to the SSSG1, and performs BWP switching. For determining the start moment of the SSSG by the terminal device, refer to the description in the method 1000. Details are not described herein again.

Sequence numbers of the foregoing processes do not mean execution sequences. The execution sequences of the processes should be determined based on functions and internal logic of the processes, but should not be construed as any limitation on the implementation processes of at least one embodiment.

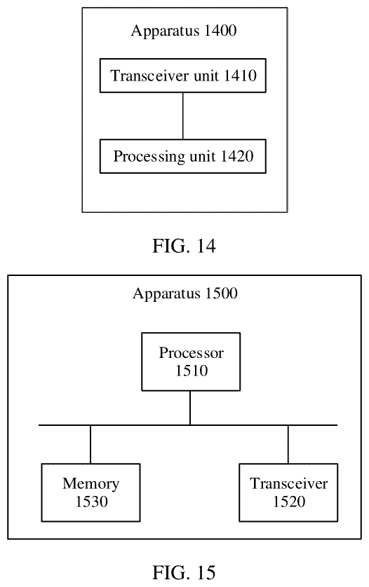

The foregoing describes in detail the method for stopping monitoring a PDCCH in at least one embodiment with reference to FIG. 1 to FIG. 13. The following describes in detail a communication apparatus in at least one embodiment with reference to FIG. 14 and FIG. 15.

FIG. 14 shows a communication apparatus 1400 according to at least one embodiment. The apparatus 1400 includes a transceiver unit 1410 and a processing unit 1420.

In an optional example, a person skilled in the art understands that the apparatus 1400 is specifically the terminal device in the method 600, the method 800, or the method 1000, or a function of the terminal device in the method 600, the method 800, the method 1800, or the method 1000 is integrated into the apparatus 1400. The foregoing function is implemented by hardware, or is implemented by hardware executing corresponding software. The hardware or the software includes one or more modules corresponding to the foregoing function. The apparatus 1400 is configured to perform procedures and/or steps corresponding to the terminal device in the foregoing method embodiments.

For example, the apparatus 1400 is specifically the terminal device in the method 600. The transceiver unit 1410 is configured to receive first downlink control information DCI from a network device on an active downlink DL bandwidth part BWP, where the first DCI indicates the apparatus to stop monitoring a PDCCH within a first duration, and the PDCCH on which monitoring is stopped includes a PDCCH in a type 3 common search space set and a PDCCH in an apparatus-specific search space set. The processing unit 1420 is configured to: run a timer, where the timer is used for BWP switching, and an expiration moment of the timer is earlier than an end moment of the first duration; stop monitoring the PDCCH within the first duration and before the timer expires; and perform DL BWP switching in response to the timer expiring, and monitoring the PDCCH on a switched-to DL BWP.

Optionally, the processing unit 1420 is further configured to: start or restart the timer in response to indication information from the network device being received on the active DL BWP, where the indication information is used to schedule the apparatus to transmit a physical downlink shared channel PDSCH or a physical uplink shared channel PUSCH, or the indication information indicates the apparatus to perform DL BWP switching, and the indication information is carried in the first DCI or DCI other than the first DCI.

Optionally, a length of the first duration is configured by using radio resource control RRC or indicated by the first DCI.

Optionally, the apparatus 1400 determines a start moment of the first duration based on at least one of the following information: a time offset between the start moment of the first duration and the first DCI; a maximum value between a minimum slot offset and a duration for parsing the first DCI, where the minimum slot offset is a minimum slot offset between a PDCCH carrying the first DCI and a PDSCH that is allowed to be scheduled by using the first DCI; a moment after a hybrid automatic repeat request HARQ corresponding to a PDSCH is fed back in response to the PDSCH being scheduled by using the first DCI; or a moment after a PUSCH being transmitted in response to the PUSCH being scheduled by using the first DCI.

For example, the apparatus 1400 is specifically the terminal device in the method 800. The transceiver unit 1410 is configured to perform a transceiver action corresponding to the terminal device in S801 in the method 800, and the processing unit 1420 is configured to perform a processing action corresponding to the terminal device in the method 800. In an optional example, a person skilled in the art understands that the apparatus 1400 is specifically the network device in the method 600, the method 800, the method 1800, or the method 1000, or a function of the network device in the method 600, the method 800, the method 1800, or the method 1000 is integrated into the apparatus 1400. The foregoing function is implemented by hardware, or is implemented by hardware executing corresponding software. The hardware or the software includes one or more modules corresponding to the foregoing function. The apparatus 1400 is configured to perform procedures and/or steps corresponding to the network device in the foregoing method embodiments.

For example, the apparatus 1400 is specifically the network device in the method 800. The transceiver unit 1410 is configured to perform a transceiver action corresponding to the network device in S801 in the method 800, and the processing unit 1420 is configured to perform a processing action corresponding to the network device in the method 800.

The apparatus 1400 is all implemented in a form of a functional unit. The term “unit” herein refers to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art understands that the apparatus 1400 is specifically the terminal device or the network device in the foregoing method embodiments, or a function of the terminal device or the network device in the foregoing method embodiments is integrated into the apparatus 1400. The apparatus 1400 is configured to perform procedures and/or steps corresponding to the terminal device or the network device in the foregoing method embodiments. To avoid repetition, details are not described herein again.

The apparatus 1400 has a function of implementing a corresponding step performed by the terminal device or the network device in the foregoing method embodiments. The foregoing function is implemented by hardware, or is implemented by hardware executing corresponding software. The hardware or the software includes one or more modules corresponding to the foregoing function.

In at least one embodiment, the communication apparatus in FIG. 14 alternatively is a chip or a chip system, for example, a system on chip (SoC).

FIG. 15 is a schematic block diagram of another communication apparatus 1500 according to at least one embodiment. The apparatus 1500 includes a processor 1510, a transceiver 1520, and a memory 1530. The processor 1510, the transceiver 1520, and the memory 1530 communicate with each other through an internal connection path. The memory 1530 is configured to store instructions. The processor 1510 is configured to execute the instructions stored in the memory 1530, to control the transceiver 1520 to send a signal and/or receive a signal.

The apparatus 1500 is specifically the terminal device or the network device in the method 600, the method 800, the method 1800, or the method 1000, or a function of the terminal device or the network device in the method 600, the method 800, the method 1800, or the method 1000 is integrated into the apparatus 1500. The apparatus 1500 is configured to perform steps and/or procedures corresponding to the terminal device or the network device in the method 600, the method 800, the method 1800, or the method 1000. Optionally, the memory 1530 includes a read-only memory and a random access memory, and provides instructions and data for the processor. A part of the memory further includes a non-volatile random access memory. For example, the memory further stores information of a device type. The processor 1510 is configured to execute the instructions stored in the memory. In response to the processor executing the instructions, the processor performs the steps and/or procedures corresponding to the terminal device or the network device in the method 600, the method 800, the method 1800, or the method 1000.

In at least one embodiment, the processor 1510 is a central processing unit (CPU). Alternatively, the processor is another general-purpose processor, a digital signal processor (DSP), an application-specific integrated circuit (ASIC), a field-programmable gate array (FPGA) or another programmable logic device, a discrete gate or a transistor logic device, a discrete hardware component, or the like. The general-purpose processor is a microprocessor, or the processor is any conventional processor or the like.

In an implementation process, the steps of the foregoing methods are implemented by an integrated logic circuit of hardware or instructions in a form of software in the processor. The steps of the methods disclosed with reference to at least one embodiment are directly performed and accomplished by a hardware processor, or is performed and accomplished by using a combination of hardware and a software module in the processor. The software module is located in a mature storage medium in the art, such as a random access memory, a flash memory, a read-only memory, a programmable read-only memory, an electrically erasable programmable memory, or a register. The storage medium is located in the memory, and the processor executes the instructions in the memory, and implements the steps of the foregoing methods in combination with hardware of the processor. To avoid repetition, details are not described herein again.

At least one embodiment further provides a computer-readable storage medium. The computer-readable storage medium is configured to store a computer program, and the computer program is used to implement a method corresponding to the terminal device or the network device in the foregoing method embodiments.

At least one embodiment further provides a computer program product. The computer program product includes a computer program (which is also referred to as code or instructions). In response to the computer program being run on a computer, the computer performs a method corresponding to the terminal device or the network device shown in the foregoing method embodiments.

A person of ordinary skill in the art is aware that units and algorithm steps in the examples described with reference to embodiments disclosed in at least one embodiment is implemented by electronic hardware or a combination of computer software and electronic hardware. Whether the functions are performed by hardware or software depends on particular applications and design constraint conditions of the technical solutions. A person skilled in the art uses different methods to implement the described functions for each particular application, but the implementation is not considered to go beyond the scope of embodiments described herein.

A person skilled in the art understands that, for the purpose of convenient and brief description, for a detailed working process of the foregoing systems, apparatuses, and units, refer to a corresponding process in the foregoing method embodiments. Details are not described herein again.

In the several embodiments provided herein, the disclosed systems, apparatuses, and methods are implemented in other manners. For example, the described apparatus embodiments are merely examples. For example, division into the units is merely logical function division and is other division during actual implementation. For example, a plurality of units or components is combined or integrated into another system, or some features are ignored or not performed. In addition, the displayed or discussed mutual couplings or direct couplings or communication connections are implemented through some interfaces. The indirect couplings or communication connections between the apparatuses or units are implemented in an electronic form, a mechanical form, or another form.

The units described as separate parts are or are not physically separate, and parts displayed as units are or are not be physical units, in other words, is located in one position, or is distributed on a plurality of network units. Some or all of the units are selected based on actual usage to achieve the objectives of the solutions of embodiments.

In addition, functional units in at least one embodiment are integrated into one processing unit, or each of the units exist alone physically, or two or more units are integrated into one unit.

The foregoing descriptions are merely specific implementations of embodiments, but are not intended to limit the protection scope of embodiments described herein. Any variation or replacement readily figured out by a person skilled in the art within the technical scope disclosed herein shall fall within the protection scope of at least one embodiment. Therefore, the protection scope of embodiments described herein shall be subject to the protection scope of the claims.

1. A method for stopping monitoring a physical downlink control channel (PDCCH), performed by a terminal device or a chip of the terminal device, comprising:
receiving first downlink control information (DCI) from a network device on an active downlink (DL) bandwidth part (BWP), wherein the first DCI is usable to indicate the terminal device to stop monitoring a PDCCH within a first duration, and the PDCCH on which monitoring is stopped includes a PDCCH in a type 3 common search space set and a PDCCH in a terminal device-specific search space set;
running a timer, wherein the timer is usable for BWP switching, and an expiration moment of the timer and a BWP switch delay are earlier than an end moment of the first duration;
stopping monitoring the PDCCH within the first duration and before the BWP switch delay ends; and
performing DL BWP switching when the timer expires, and monitoring the PDCCH on a switched-to DL BWP.

2. The method according to claim 1, wherein the running a timer includes:
starting or restarting the timer when the terminal device receives indication information from the network device on the active DL BWP, wherein
the indication information is usable to schedule the terminal device to transmit a physical downlink shared channel (PDSCH) or a physical uplink shared channel (PUSCH), or the indication information is usable to indicate the terminal device to perform DL BWP switching, and the indication information is carried in the first DCI or DCI other than the first DCI.

3. The method according to claim 1, wherein the receiving the first DCI that is usable to indicate the terminal device to stop monitoring a PDCCH within a first duration includes receiving the first DCI that is usable to indicate the terminal device to stop monitoring a PDCCH within a first duration having a length configured through radio resource control (RRC) or indicated by the first DCI.

4. The method according to claim 1, wherein the receiving the first DCI that is usable to indicate the terminal device to stop monitoring a PDCCH within a first duration includes includes receiving the first DCI that is usable to indicate the terminal device to stop monitoring a PDCCH within a first duration having a start at a beginning of next slot for the first DCI.

5. The method according to claim 1, wherein the method further comprises:
performing PDCCH monitoring on the swiched-to BWP based on a configured seach space set when no SSSG is configured on the switched-to BWP.

6. The method according to claim 1, wherein the method further comprises:
performing PDCCH monitoring on the swiched-to BWP based on a search space set within a SSSG with an index 0 when at least one SSSG including the SSSG with the index 0 is configured on the switched-to BWP.

7. An apparatus, comprising:
at least one memory storing instructions; and
at least one processor coupled to the memory, wherein the at least one processor is configured to execute the instructions to perform operations of:
receiving first downlink control information (DCI) from a network device on an active downlink (DL) bandwidth part (BWP), wherein the first DCI is usable to indicate to stop monitoring a physical downlink control channel (PDCCH) within a first duration, and the PDCCH on which monitoring is stopped includes a PDCCH in a type 3 common search space set and a PDCCH in a terminal device-specific search space set;
running a timer, wherein the timer is usable for BWP switching, and an expiration moment of the timer and a BWP switch delay are earlier than an end moment of the first duration;
stopping monitoring the PDCCH within the first duration and before the BWP switch delay ends; and
performing DL BWP switching when the timer expires, and monitoring the PDCCH on a switched-to DL BWP.

8. The apparatus according to claim 7, wherein the at least one processor is configured to run the timer by:
starting or restarting the timer when the indication information is received from the network device on the active DL BWP, wherein
the indication information is usable to schedule transmission of a physical downlink shared channel (PDSCH) or a physical uplink shared channel (PUSCH), or the indication information is usable to indicate the terminal device to perform DL BWP switching, and the indication information is carried in the first DCI or DCI other than the first DCI.

9. The apparatus according to claim 7, wherein a length of the first duration is configured through radio resource control (RRC) or indicated by the first DCI.

10. The apparatus according to claim 7, wherein a start of the first duration is a beginning of next slot for the first DCI.

11. The apparatus according to claim 7, wherein the at least one processor is further configured to perform operations of:
performing PDCCH monitoring on the swiched-to BWP based on a configured seach space set when no SSSG is configured on the switched-to BWP.

12. The apparatus according to claim 7, wherein the at least one processor is further configured to perform operations of:
performing PDCCH monitoring on the swiched-to BWP based on a search space set within a SSSG with an index 0 when at least one SSSG including the SSSG with the index 0 is configured on the switched-to BWP.

13. An apparatus, comprising:
at least one memory storing instructions; and
at least one processor coupled to the memory, wherein the at least one processor is configured to execute the instructions to perform operations of:
sending first downlink control information (DCI) to a terminal device on an active downlink DL bandwidth part BWP, wherein the first DCI is usable to indicate to stop monitoring a PDCCH within a first duration, and the PDCCH on which monitoring is stopped includes a PDCCH in a type 3 common search space set and a PDCCH in a terminal device-specific search space set;
running a timer, wherein the timer is usable for BWP switching and an expiration moment of the timer is earlier than an end moment of the first duration;
suspending running of the timer within the first duration;
continuing to run the timer after the first duration; and
performing DL BWP switching when the timer expires.

14. The apparatus according to claim 13, wherein a length of the first duration is configured through radio resource control (RRC) or indicated by the first DCI.

15. The apparatus according to claim 13, wherein a start of the first duration is a beginning of next slot for the first DCI.
